(19) United States
(12) Patent Application Publication
(10) Pub. No.: US 2018/0276586 A1
(43) Pub. Date: Sep. 27, 2018

(54) SYSTEMS AND METHODS FOR ROUTING VEHICLES AND SCHEDULING VEHICLE RIDES

(71) Applicant: Zyleck Technologies, Inc., Smyrna, GA (US)

(72) Inventor: Michael Wayne Treasure, Smyrna, GA (US)

(73) Assignee: Zyleck Technologies, Inc., Smyrna, GA (US)

(21) Appl. No.: 15/883,928

(22) Filed: Jan. 30, 2018

Related U.S. Application Data
(60) Provisional application No. 62/443,339, filed on Jan. 6, 2017.

(51) Int. Cl. G06Q 10/06

(52) U.S. Cl. CPC G06Q 10/06312; G05D 1/0291; G06Q 10/0633

(57) ABSTRACT

The disclosure relates to systems and methods for routing vehicles and scheduling vehicle rides. In a system embodiment, a computer processor operable to execute computer-executable instructions, and a memory comprising computer-executable instructions can be provided. The computer-executable instructions can be operable to, prior to a predefined cutoff time and based at least in part on the start time and the end time for a first driver, generate a sequenced list of vehicle rides; determine, prior to the predefined cutoff time, a revenue potential for each hour increment between the start time and the end time; modify, based at least in part on implementation of a metaheuristic algorithm, and after the predefined cutoff time, the sequenced list; and output, via a graphical user interface, the modified sequenced list to the first driver, wherein the graphical user interface comprises a list of optimized vehicle rides.

### RELATED APPLICATION

The present application claims priority to U.S. Provisional Ser. No. 62/443,339, filed Jan. 30, 2017, titled “Vehicle Routing Problem with Prescheduled Driver Match with Inventoried Rides,” the content of which is incorporated by reference.

### TECHNICAL FIELD

This disclosure relates to scheduling vehicles, and more particularly to, systems and methods for routing vehicles and scheduling vehicle rides.

### BACKGROUND OF THE DISCLOSURE

Conventional rideshare services typically rely on drivers using privately-owned vehicles to serve passengers who want to travel from one location to another Some conventional rideshare services deliver packages for online retailers and meal orders from restaurants. Certain factors exist that can hamper the effectiveness of a conventional rideshare service. For example, prior to a customer initiating a ride with a rideshare service, the rideshare service does not know when the customer will request a ride, and, further, the rideshare service does not know where the passenger needs to be picked up. The inability to answer these questions hampers the ability of the rideshare service to know how many vehicles may be needed for a predefined location, and this can lead to an increase in the wait time for a customer to get a ride. When insufficient vehicles are not available or otherwise scheduled for a particular location, this can ultimately decrease the effectiveness of a rideshare service as well as decrease drivers' income when drivers are unable to serve customers quickly and efficiently.

For example, potential passengers may want a vehicle, or package delivery shippers and recipients may need to be served by a courier delivery service for package deliveries. In either instance, collectively, the potential passengers and package delivery shippers or recipients can be referred to as “passengers” or “riders”. Further, in either instance, the passenger or the package delivery shipper or recipient seeks to schedule a “ride” with a rideshare service, also referred to as a “TNC” or transport network company” Generally, these passengers or riders are waiting within about a 10-mile radius of each other. Each passenger or rider may be willing to wait up to about 15 minutes from the moment each needs a vehicle ride to the time a vehicle arrives or needs to be served by a courier delivery service. A TNC, which can administer or otherwise facilitate a platform or network to serve its drivers and passengers, may want to serve all passengers, but the TNC does not know precisely when each passenger will request a ride via the platform or network, nor does the TNC know precisely where each passenger will need to be picked up or need to be served by a courier delivery service. Therefore, a TNC may decide to keep about 100 vehicles in and around the 10-mile radius to try to quickly satisfy the need of each passenger or rider, once a passenger or rider decides on a time and place of pickup or a package delivery via the platform or network.

Generally, a conventional TNC does not own any vehicles, but rather, independent drivers own and operate the vehicles serving the TNC. Therefore, the TNC is generally not concerned about the cost of operating the vehicles, including not being concerned about unloaded miles, nor is the TNC concerned about the length of time each of the 100 vehicles need to wait around in order to be dispatched to a waiting passenger or rider. For a conventional TNC, the primary concerns may be (1) meet each passenger or rider request for an affordable ride or package delivery as quickly as possible, and (2) make sure the TNC has sufficient vehicles serving the TNC's needs in order to meet the initial concern.

Many drawbacks exist for the conventional TNCs that administer a platform or network used to serve the TNC's passengers or riders.

### BRIEF DESCRIPTION OF THE DISCLOSURE

Embodiments of the disclosure relate to systems and methods for routing vehicles and scheduling vehicle rides. Furthermore, certain embodiments of the disclosure can relate to systems and methods to route vehicles and schedule vehicle rides associated with package delivery.

According to one exemplary embodiment of the disclosure, systems and methods for routing vehicles and scheduling vehicle rides can be provided. For example, assume there are 50 potential passengers or package delivery recipients (collectively, again, referred to as “passengers” or “riders”) within a 10-mile radius of each other, and each passenger or rider wants a vehicle or needs to be served by a courier delivery service with package deliveries. Each passenger or rider may be willing to wait, by indicating via a TNC's platform or network ahead of a specific pickup time, at least 15 minutes for a vehicle, for either a ride or to be served by a courier delivery service. The TNC may learn that each passenger or rider is also prepared to provide, in advance of pickup, an exact location and a specific pickup or delivery time. In this example, the TNC knows ahead of time the exact pickup or delivery time and location of each of the 50 passengers or riders. With this knowledge, the TNC can determine that only 18 vehicles are needed to serve the 50 passengers' or riders' vehicle needs, and that all 18 vehicles do not have to be waiting in and around the 10-mile radius. That is, the TNC can schedule, sequence and route in and out, each of the 18 vehicles to meet the needs of the 50 passengers or riders.

Since the TNC may not own the vehicles, and independent drivers own and operate the vehicles serving the TNC network, the TNC may be concerned about the drivers' respective costs of operating their vehicles, including being concerned about minimizing unloaded miles, and the TNC may also be concerned about the length of time each vehicle waits around to be provided with a passenger or rider who requests a vehicle via the TNC's platform or network. Thus, the TNC can (1) meet each passenger request for an affordable ride or delivery at the precise time and place needed, and (2) minimize the uncertainty for each driver as to when and where a passenger will need to be served, so that operational cost of each vehicle is minimized or otherwise reduced.

According to one exemplary embodiment of the disclosure, a system for routing vehicles and scheduling vehicle rides can exist. The system can include a computer processor operable to execute computer-executable instructions, and a memory comprising computer-executable instructions. The computer-executable instructions can be operable to receive one or more driver inputs comprising a start time for each driver, an end time for each driver, a start location for each driver, and an end location for each driver. The instructions can be further operable to receive one or more requests for a vehicle ride, the requests comprising a start location or each ride and an end location for each ride. Further, the instructions can be operable to for a first driver, prior to a predefined cutoff time and based at least in part on the start time for the first driver and the end time for the first driver, generate a sequenced list of vehicle rides for the first driver. Moreover, the instructions can be operable to determine, prior to the predefined cutoff time, a revenue potential for each hour increment between the start time for the first driver and the end time for the first driver. Further, the instructions can be operable to modify, based at least in part on implementation of a metaheuristic algorithm, and after the predefined cutoff time, the sequenced list of the first driver. The instructions can be further operable to output, via a graphical user interface, the modified sequenced list to the first driver, wherein the graphical user interface comprises a list of optimized vehicle rides.

In one aspect of one embodiment, the sequenced list can be further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver; minimizing unloaded miles, and minimizing wait time between rides.

In one aspect of one embodiment, the driver can be an autonomous vehicle.

In one aspect of one embodiment, the vehicle ride can be a ride for a person, package, or a pet.

In one aspect of one embodiment, the implementation of a metaheuristic algorithm can include computer-executable instructions operable to check an inventory of rides within a predefined distance from the start location of the first driver and the end location of the first driver; generate an initial restricted list including a ride closest to the start location of the first driver and a ride closest to the end location of the first driver; assign rides from the inventory to the initial restricted list based at least in part on the total estimated duration of the rides, or the ability of the ride to be completed between the start time for the first driver and the end time for the first driver; minimize unloaded miles; and minimize wait time between rides.

In one aspect of one embodiment, the computer-executable instructions can further include instructions operable to receive a request from a delivery recipient to modify a delivery by the first driver, further modify, based at least in part on request from the delivery recipient, and after the predefined cutoff time, the sequenced list of the first driver; and output, via a graphical user interface, the further modified sequenced list to the first driver, wherein the graphical user interface comprises a list of optimized vehicle rides including a delivery to delivery recipient.

In one aspect of one embodiment, the delivery can include a package or a pet.

According to one exemplary embodiment of the disclosure, a computer-implemented method for routing vehicles and scheduling vehicle rides can exist. The method can include receiving one or more driver inputs comprising a start time for each driver, an end time for each driver, a start location for each driver, and an end location for each driver. The method can further include receiving one or more requests for a vehicle ride, the requests comprising a start location for each ride and an end location for each ride. The method can further include, for a first driver, prior to a predefined cutoff time and based at least in part on the start time for the first driver and the end time for the first driver, generating a sequenced list of vehicle rides for the first driver. Further, the method can include determining, prior to the predefined cutoff time, a revenue potential for each hour increment between the start time for the first driver and the end time for the first driver. Moreover, the method can include modifying, based at least in part on implementation of a metaheuristic algorithm, and after the predefined cutoff time, the sequenced list of the first driver. The method can also include outputting, via a graphical user interface, the modified sequenced list to the first driver, wherein the graphical user interface comprises a list of optimized vehicle rides.

In one aspect of one embodiment, the sequenced list can be further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver; minimizing unloaded miles, and minimizing wait time between rides.

In one aspect of one embodiment, the driver can be an autonomous vehicle.

In one aspect of one embodiment, the vehicle ride can be a ride for a person, package, or a pet.

In one aspect of one embodiment, the implementation of a metaheuristic algorithm can include checking an inventory of rides within a predefined distance from the start location of the first driver and the end location of the first driver; generating an initial restricted list including a ride closest to the start location of the first driver and a ride closest to the end location of the first driver; assigning rides from the inventory to the initial restricted list based at least in part on the total estimated duration of the rides, or the ability of the ride to be completed between the start time for the first driver and the end time for the first driver; minimizing unloaded miles; and minimizing wait time between rides.

In one aspect of one embodiment, the computer-implemented method can include receiving a request from a delivery recipient to modify a delivery by the first driver, further modifying, based at least in part on request from the delivery recipient, and after the predefined cutoff time, the sequenced list of the first driver; and outputting, via a graphical user interface, the further modified sequenced list to the first driver, wherein the graphical user interface comprises a list of optimized vehicle rides including a delivery to delivery recipient.

In one aspect of one embodiment, the delivery can include a package or a pet.

According to one exemplary embodiment of the disclosure, a computer-readable medium for routing vehicles and scheduling vehicle rides can exist. The computer-readable medium can include computer-executable instructions operable to receive one or more driver inputs comprising a start time for each driver, an end time for each driver, a start location for each driver, and an end location for each driver. The instructions can be further operable to receive one or more requests for a vehicle ride, the requests comprising a start location or each ride and an end location for each ride. The instructions can be further operable to, for a first driver, prior to a predefined cutoff time and based at least in part on the start time for the first driver and the end time for the first driver, generate a sequenced list of vehicle rides for the first driver. Further, the instructions can be operable to determine, prior to the predefined cutoff time, a revenue potential for each hour increment between the start time for the first driver and the end time for the first driver. Moreover, the instructions can be operable to modify, based at least in part on implementation of a metaheuristic algorithm, and after the predefined cutoff time, the sequenced list of the first driver. Further, the instructions can be operable to output, via a graphical user interface, the modified sequenced list to the first driver, wherein the graphical user interface comprises a list of optimized vehicle rides.

In one aspect of one embodiment, the sequenced list can be further based at least in part on a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver, minimizing unloaded miles, and minimizing wait time between rides.

In one aspect of one embodiment, the driver can be an autonomous vehicle.

In one aspect of one embodiment, the vehicle ride can be a ride for a person, package, or a pet.

In one aspect of one embodiment, the implementation of a metaheuristic algorithm can include computer-executable instructions operable to check an inventory of rides within a predefined distance from the start location of the first driver and the end location of the first driver; generate an initial restricted list including a ride closest to the start location of the first driver and a ride closest to the end location of the first driver, assign rides from the inventory to the initial restricted list based at least in part on the total estimated duration of the rides, or the ability of the ride to be completed between the start time for the first driver and the end time for the first driver; minimize unloaded miles; and minimize wait time between rides.

In one aspect of one embodiment, the computer-executable instructions can further include instructions operable to receive a request from a delivery recipient to modify a delivery by the first driver; further modify, based at least in part on request from the delivery recipient, and after the predefined cutoff time, the sequenced list of the first driver; and output, via a graphical user interface, the further modified sequenced list to the first driver, wherein the graphical user interface comprises a list of optimized vehicle rides including a delivery to delivery recipient.

In one aspect of one embodiment, the delivery can include a package or a pet.

The disclosure will be described more fully hereinafter with reference to the drawings, in which exemplary embodiments of the disclosure are shown. This disclosure may, however, be embodied in many different forms and should not be construed as limited to the exemplary embodiments set forth herein; rather, these embodiments are provided so that this disclosure will satisfy applicable legal requirements Like numbers refer to like elements throughout. It should be understood that certain words and terms are used herein solely for convenience and such words and terms should be interpreted as referring to various objects and actions that are generally understood in various forms and equivalencies by persons of ordinary skill in the art. For example, the word “example” as used herein is intended to be non-exclusionary and non-limiting in nature. More particularly, the word “exemplary” as used herein indicates one among several examples, and it should be understood that no undue emphasis or preference is being directed to the particular example being described Other embodiments and aspects of the disclosure will become apparent from the following description taken in conjunction with the following drawings.

### BRIEF DESCRIPTION OF DRAWINGS

Having thus described the disclosure in general terms, reference will now be made to the accompanying drawings, which are not necessarily drawn to scale, and wherein:

FIGS. 1 and 2 illustrates an example process flow for systems and methods according to certain embodiments of the disclosure.

FIGS. 3-5 illustrate example user interfaces for systems and methods according to certain embodiments of the disclosure.

FIGS. 6-13 illustrate example model schematics for systems and methods according to certain embodiments of the disclosure.

FIG. 14 illustrates an example flowchart for systems and methods according to certain embodiments of the disclosure.

FIGS. 15-19 illustrate example model schematics overlaid on an example region for systems and methods according to certain embodiments of the disclosure.

FIGS. 20-22 illustrate other example user interfaces for systems and methods according to certain embodiments of the disclosure.

FIG. 23 illustrates an example environment and computer network architecture for communicating with driver/vehicles and passengers or riders via a network, according to certain embodiments of the disclosure.

Tables 1-9 illustrate example implementations of systems and methods according to certain embodiments of the disclosure.

### DETAILED DESCRIPTION OF CERTAIN EMBODIMENTS OF THE DISCLOSURE

In terms of a general overview, certain embodiments of the systems and methods described herein can route vehicles and schedule vehicle rides.

In one embodiment, a system uses mobile telecommunications and cloud-based technologies to match potential drivers/vehicles, wherein each “driver/vehicle” can be, either a person or an autonomous vehicle, performing the driving function, with or without a physical driver present, with respective potential riders or package delivery recipients willing to pay or have paid a fare for point-to-point transportation. Each “rider” or “passenger” can be a person, animal, package, or a combination of two or more of them. Driver/vehicles are generally independent contractors, using personal or company-supplied vehicles to provide service. In some embodiments, the vehicles may be autonomous or semi-autonomous, but may still be privately-owned, company-owned, and/or company-leased vehicles. A “ride” or “trip” is a single transaction from one point to another point, or a start location to an end location. In any instance, rider transactions with each of the driver/vehicles, and company transactions with each of the driver/vehicles are generally cashless, and handled through the use of respective apps or applications executing on smartphones or other processor-based devices, via communication with a platform or network administered by or otherwise facilitated by a TNC or transport network company.

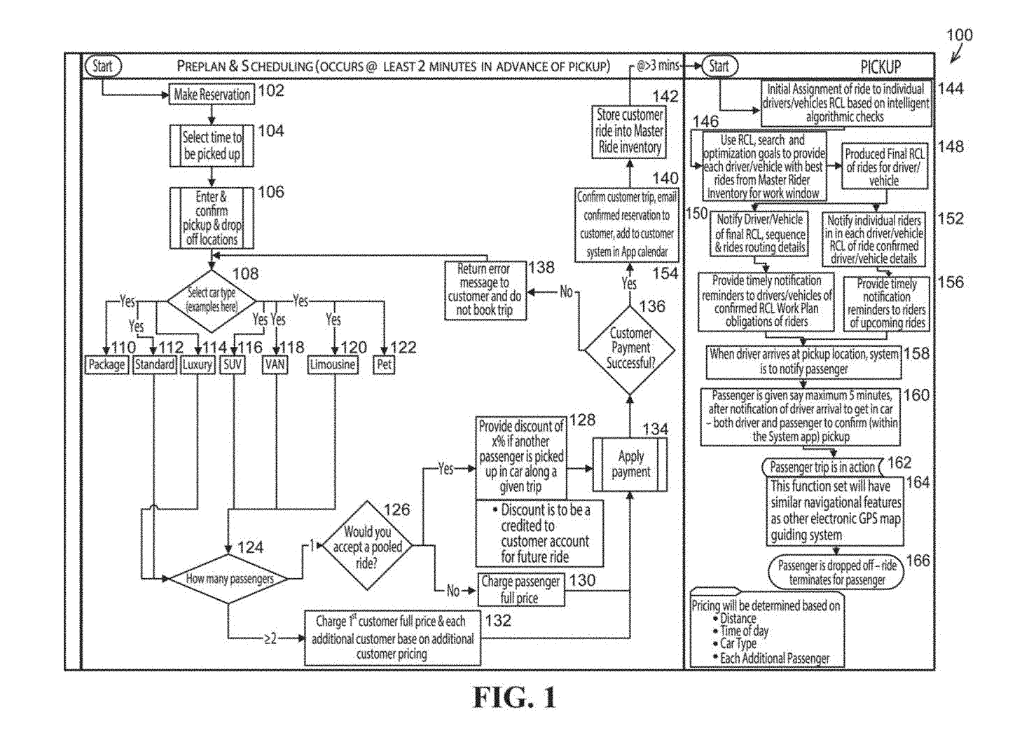

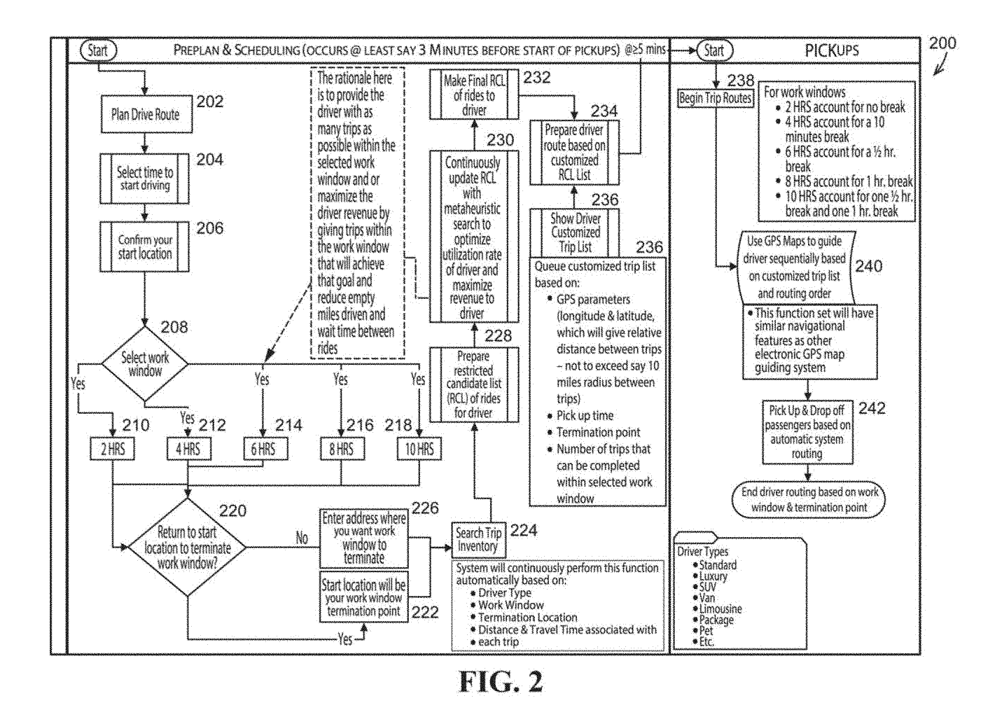

FIGS. 1 and 2 illustrate a process flow for an example system and method according to certain embodiments of the disclosure. Generally, the process flow 100 illustrates a method to pre-arrange, match, sequence, and route any number of rides or trips and driver/vehicles via any number of algorithms being processed on cloud-based or other processors, and respective apps or applications executing on smartphones or other processor-based devices.

Generally, a rider can schedule a ride or trip ahead of a pickup time and/or delivery time, and be given a minimum time between the time of scheduling the pickup and the time the actual pickup/delivery may occur. As opposed to conventional TNCs, riders are not able to hail a ride or trip and receive service based on the nearest service driver/vehicle, but rather riders using the new TNC can know ahead of time, for example, 15 minutes ahead of time, the driver/vehicle details dispatched for pickup. Operations 102-138 explain an example ride scheduling process according to an embodiment of the disclosure.

In operation 102, a reservation is made by a rider via an app or application executing on a smartphone or other processor-based device Operation 102 is followed by operation 104, in which the rider, via the app or application, selects a time to be picked up. Operation 104 is followed by operation 106, in which the rider enters and confirms, via the app or application, a pickup location and a drop off location. Operation 106 is followed by operation 108, in which the rider, via the app or application, selects a car type. The car type can include, but is not limited to, a package, a standard, luxury, sport utility vehicle (SUV), van, limousine, and pet. These respective options, by way of example only, are shown as operations 110, 112, 114, 116, 118, 120, and 122. As needed, other car types can exist and can be selected by a rider via the app or application.

Upon selection of operation 110, the rider, or shipper in this example, indicates a desire to ship a package via a vehicle. The shipper is provided with a form via a user interface on a smartphone or other processor-based device to input details regarding a package to be delivered. Such details may include, but are not limited to, dimensions, weight, pictures, videos, pickup location, drop off location, phone number, email, user name, delivery recipient, and other preferences regarding notifications or messages. In some instances, a shipper can be representative of a company or organization that desires to use the TNC as a logistic fulfillment service to pickup and drop off one or more packages to a customer or package delivery recipient. Upon receiving suitable shipment information, the platform creates a transaction for the shipment, and the transaction becomes a ride object, which can be treated as a ride by the platform, with a demarcation, for example, p=package. The allocation to a driver/vehicle restricted candidate list (RCL) can be treated similar to a ride or trip for a passenger or a rider, and thus can be provisioned, sequenced, and routed to the driver/vehicle similar to any other ride object with the demarcation specification to inform the driver of the ride object type. Operation 110 is followed by operation 130 described below.

Operations 112, 114, 116, 118, and 120 are followed by decision block 124, in which a number of passengers is selected by the rider. If a selection of “1” is made by a rider, then in decision block 126, the rider is queried whether a car pool is acceptable, such as by asking, “Would you accept a pooled ride?” If the rider responds “Yes”, the branch is followed to operation 128, in which a discount can be provided to the rider if another passenger is picked up by the vehicle along the rider's route. The discount can be credited to an account associated with the rider or the discount can be applied to the rider's fare for the present ride or route. Operation 128 is followed by operation 134 explained below.

Upon selection of operation 122, the rider, or custodian of a pet in this example, indicates a desire to ship a pet or animal via a vehicle. The request can be treated by the platform similar to a ride request from a rider or passenger. Upon receiving suitable ride information, the platform can create a transaction, and the transaction becomes a ride object, which is treated similar to other rides by the platform, with a demarcation, for example, p=PET. The allocation to a driver/vehicle RCL can be treated similar a ride or trip for a passenger or a rider, and thus can be provisioned, sequenced, and routed to the driver/vehicle similar to any other ride object with the demarcation specification to inform the driver of the ride object type. Operation 122 is followed by operation 130 described below.

Turning back to decision block 126, if a selection of “No” is made by a rider, then the branch is followed to operation 130, in which the rider is charged full price or fare for the ride or trip. Operation 130 is followed by operation 134 explained below.

Returning back to decision block 124, if the selection of “2 or more” is made by a rider, then in operation 132, the customer can be charged full price and each additional customer can be charged based on additional customer pricing.

Operations 128, 130, and 132 are followed by operation 134, in which a payment is applied. For example, since payments are cashless, a credit card or debit card can be processed by a payment processor. The credit card or debit card, or other payment account details can be transmitted to one or more payment processors for processing, and payment proceeds can be settled with the TNC acting as a merchant in the transaction. The payment received can be made by one or more payment methods and may include a TNC-issued or otherwise accepted coupon or discount code to offset some or all of the payment.

Operation 134 is followed by decision block 136, in which a determination is made whether the payment processing was successful. That is, the payment processor determines whether the payment processing is successful, and communicates via the platform with the TNC about whether the payment processing is successful. If the payment processing is not successful, then the “No” branch is followed to operation 138, in which an error message is returned to the rider and a ride is not booked by the TNC platform. After operation 138, the method returns to operation 106, for which the rider is given another opportunity to enter and confirm, via the app or application, a new pickup location and a new drop off location.

Returning to decision block 136, if the payment processing is successful, then the “Yes” branch is followed to operation 140, in which the rider's trip is confirmed, a communication confirming the trip is generated and transmitted to the rider via the app or application, and a calendar entry can be generated and transmitted to the rider via the app or application. Operation 140 is followed by operation 142, in which the rider's trip is stored in a master ride inventory for further processing. One or more riders' ride or trip requests can be placed into a master ride inventory stored in a database memory, or other storage device. The master ride inventory is an initial inventory list of rides or trips requested by one or more riders.

Turning to FIG. 2, in operation 202, a driver/vehicle can interact with a user interface on a smartphone or other processor-based device to create a work plan to drive one or more routes the platform may intelligently provision to the driver/vehicle for a created and confirmed work plan. Upon selection of an option to create a work plan, operation 202 is followed by operation 204, in which the platform offers the driver/vehicle an option to select a time to start driving. For example, a driver/vehicle can decide to begin a work plan at 6:00 a.m., and select a user option corresponding with 8:00 a m. Operation 204 is followed by operation 206, in which the driver/vehicle can provide a starting physical location. The driver/vehicle can interact with a user interface on a smartphone or other processor-based device, and indicate his/her a starting physical location, such as a physical address, “123 North Avenue”, or a pin on a map. Operation 206 is followed by decision block 208, in which a work window is selected. That is, after the driver/vehicle has selected a start time and a start location, the driver/vehicle can schedule a work window, also known as a work plan, based at least in part on a list of selectable options. A work window is a time slot that a driver/vehicle intends to work for defined period of the time. For example, in operations 210-218, a driver/vehicle can select a work window option such as 2, 4, 6, 8, or 10 hours. Other work window increments can exist. In any instance, a driver/vehicle may select a work window at any time in advance, such as minutes, hours, days, weeks, or months in advance of a desired work start time. In selecting a time slot, a driver/vehicle is voluntarily declaring in advance a time to begin a selected work window, and the selection of the time slot, selects a time to end the work window.

Regardless of the selected increment selected, upon selecting a work window increment, for example, 2 hours, the “Yes” branch is followed from decision block 208 to operation 210, and then to decision block 220, in which a determination is made whether the driver/vehicle wants to return to the start location to terminate the work window. If the driver/vehicle selects “Yes”, the branch is followed to operation 222, in which the selected or indicated start location is the termination point for the work window, and the method continues to operation 224 described below. If the driver/vehicle selects “No”, the branch is followed to operation 226, in which the driver/vehicle selects or indicates an address or pin on a map for the termination point of the work window, and the method continues to operation 224 described below.

In any instance, for example, when the driver/vehicle selects or indicates a start address, the address can be converted to a set of coordinates, such as x₁, y₁, and the work window termination location can also be converted to a set of coordinates, such as x₂, y₂. The platform can use a mapping program service, or other technology to translate start location or address and termination location or address into GPS coordinates, such as xᵢ, yᵢ and x₂, y₂.

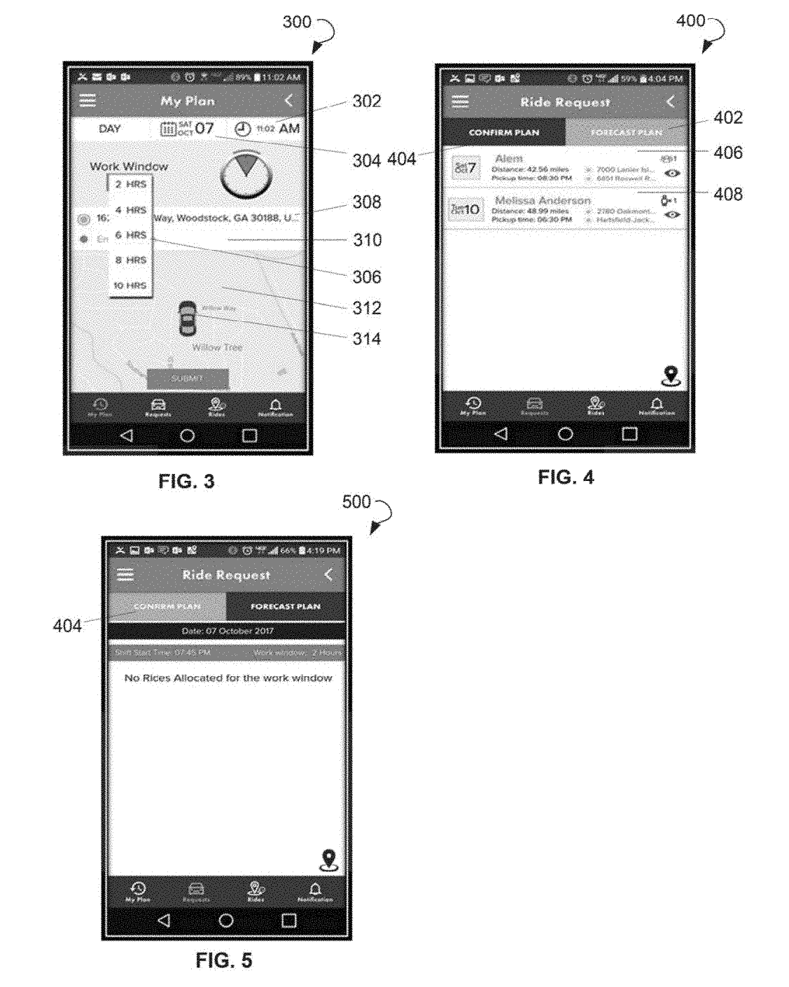

Turning to FIG. 3, an example user interface 300 for an app or application executing on a smartphone or other processor-based device is shown, in accordance with an embodiment of the disclosure. In this example, a driver/vehicle app can be used by a driver/vehicle to communicate with the TNC via a platform. The user interface shown can display a “My Plan” page to the driver/vehicle with the various parameters needed for a desired work window, such as the starting time 302 and date 304, the work window increment 306 or duration, the start location 308 and the termination or end location 310. A map 312 can also be displayed in the user interface, and may indicate the driver/vehicle current location 314, and as needed or when indicated by the driver/vehicle, the start location 308 and the termination or end location 310.

Once a driver/vehicle has indicated a desired start time, start location, and termination or end location of the selected work window, the platform can use one or more metaheuristic algorithms, previously stored in one or more memories, data storage devices, or processors, to create an initial restricted candidate list (RCL) from the master ride inventory, described at operation 142 in FIG. 1. The master ride inventory can include an inventory list of one or more rides booked and yet unserved by the platform.

Turning back to FIG. 1, a pickup routine begins at operation 144, wherein based at least in part on one or more algorithms implemented by the platform, an initial assignment of one or more rides is made to a respective RCL or restricted candidate list for each individual driver/vehicle. Various algorithms can be implemented by the platform including using an algorithmic metaheuristic search approach described below to determine one or more rides to assign to a respective RCL or restricted candidate list for each individual driver/vehicle.

FIG. 4 illustrates another example user interface in accordance with an embodiment of the disclosure. The example user interface 400 shown in FIG. 4 can be facilitated by an app or application executing on a smartphone or other processor-based device. In this example, a driver/vehicle can view a generated RCL or restricted candidate list including a forecast plan 402 and a confirmed plan 404. The forecast plan 402 can include a list of one or more rides initially allocated to the driver/vehicle for a particular active work window, but not yet finalized by the platform. The confirmed plan 404 can include a list of one or more rides that are already finalized by the platform for the driver/vehicle. The list shown in the example confirmed plan 404 includes an optimized set of rides 406, 408 available at the time (up to a specific cut in time) that met the optimization goals set by the platform for the driver/vehicle.

In any instance, the initial RCL generated by the platform and output via the user interface 400 for the driver/vehicle may include one or more rides which seek to maximize the revenue potential of the driver/vehicle during each hour of the selected work window, and further, wherein the rides may be completed within the start time and termination time of the work window while honoring the start location and termination location set by the driver/vehicle.

FIG. 4 shows, by way of example, 2 rides 406, 408 that are provisionally allocated to a specific driver/vehicle as explained above. In doing so, the platform seeks to match rides to the driver/vehicle based on maximizing the driver/vehicle's utilization rate, where the utilization rate is determined by wait time (time between paying rides, i.e., time without a paying rider onboard), and dead head/unloaded miles (miles driven without a paying rider onboard). In this example, maximizing the driver/vehicle's utilization rate means minimizing both the wait time and dead head/unloaded miles the driver/vehicle would incur during each hour of the selected work window.

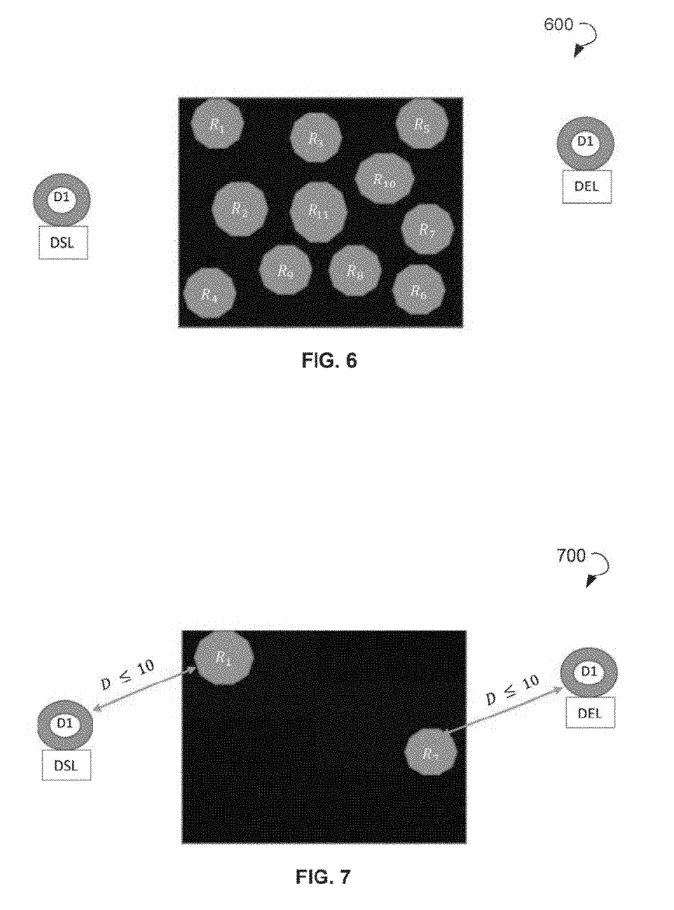

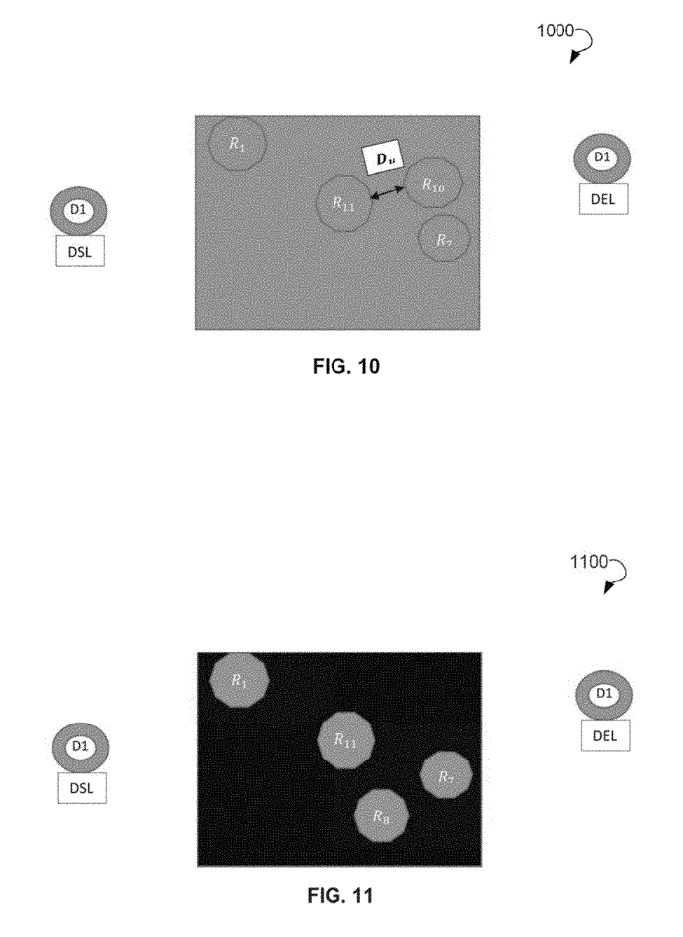

Turning back to FIG. 1, after operation 144 follows operation 146 (similar to operation 230 in FIG. 2), in which one or more algorithms can be executed, applied, run, and re-run to the initial RCL by the platform to achieve one or more optimization goals and/or objectives, which can provide each driver/vehicle with an optimum set of rides from the master inventory for the respective driver/vehicle's work window. An example algorithm, such as an algorithmic metaheuristic search approach, and set of optimization goals and/or objectives are described below with respect to FIGS. 6-13.

Operation 146 is followed by operation 148 (similar to operations 232 and 234 in FIG. 2), in which a final RCL is generated by the platform of one or more rides for a driver/vehicle.

After operation 148 is operation 150 (similar to operation 236 in FIG. 2), in which each driver/vehicle is notified of the final RCL including a sequence, ride information, and routing details. Typically, the final RCL is generated by the platform and output to a driver/vehicle via a user interface on a smartphone or other processor-based device. Further, operation 148 is also followed by operation 152, which can be executed concurrently or shortly before or after operation 150, and includes notifying individual riders identified in the rides listed in the RCL of the confirmed ride details including the driver/vehicle details.

FIG. 5 shows another user interface in accordance with an embodiment of the disclosure. The example user interface 500 shown in FIG. 5 can be facilitated by an app or application executing on a smartphone or other processor-based device. In this example, the platform can generate a confirmed work window 404 indicating any number of confirmed rides of the final RCL list for the driver/vehicle Prior to any dispatch of the driver/vehicle for an intended ride, both the driver/vehicle and the riders in the final RCL can be provided by the platform with each others' contact information, such as a mobile device number, vehicle make/model/color, license plate or vehicle registration number, email, name, nickname, identification code, and/or other identifying information via their respective apps or applications executing on their smartphones or other processor-based devices.

Operation 150 described above, is followed by operation 154, in which a timely notification of reminders is provided by the platform, or by the app or application executing on the driver/vehicle smartphone or other processor-based device, of the confirmed RCL work plan and ride obligations to the riders. The platform as well as the app or application executing on the driver/vehicle smartphone or other processor-based device can access a clock running on the platform or the app or application to provide a comparison against the various ride times, and a reminder can be generated prior to each ride, such as 5 minutes prior to a ride start time. The reminder can be generated in advance of a ride start time to account for travel time for the driver/vehicle to reach the starting point of the ride. In any instance, the reminder or other notification can be generated by the platform, and transmitted to the driver/vehicle by text, message, or within the app or application executing on the driver/vehicle smartphone or other processor-based device. Similarly, the app or application can generate a reminder or notification and transmit the reminder or notification to the driver/vehicle by text, message, or within the app or application.

Turning back to operation 1152, and concurrently executed with or slightly before or after operation 154, following operation 152 is operation 156, in which a notification or reminder is provided to the riders or passengers of upcoming rides Similar to generating notifications or reminders for the driver/vehicle, a timely notification of reminders is provided by the platform, or by the app or application executing on a passenger's or rider's smartphone or other processor-based device, of the confirmed ride obligation for each riders or passenger. The platform as well as the app or application executing on the rider's or passenger's smartphone or other processor-based device can access a clock running on the platform or the app or application to provide a comparison against the various ride times, and a reminder can be generated prior to each ride, such as 5 minutes prior to a ride start time. The reminder can be generated in advance of a ride start time to account for travel time for the rider or passenger to reach the starting point of the ride. In any instance, the reminder or other notification can be generated by the platform, and transmitted to the rider or passenger by text, message, or within the app or application executing on the rider's or passenger's smartphone or other processor-based device. Similarly, the app or application can generate a reminder or notification and transmit the reminder or notification to the rider or passenger by text, message, or within the app or application.

In any instance, after operations 154 and 156 is operation 158, in which, upon arrival of the driver/vehicle to the ride start location, the platform notifies the rider or passenger. That is, when a driver/vehicle travels to a designed ride start location to pickup a rider or passenger, the platform monitors the driver/vehicle progress and proximity to the ride start location via tracking the GPS coordinates of a smartphone or other processor-based device associated with the driver/vehicle. When a comparison of the GPS coordinates of the driver/vehicle to the GPS coordinates of the ride start location indicates the driver/vehicle is a predefined distance, for example, about 500 feet, or predefined time, for example, about 1 minute away from the ride start location, the platform can generate and transmit a notification to the rider or passenger by way of a text, message, call, or email. The rider or passenger can receive the notification via a smartphone or other processor-based device associated with the rider or passenger.

Following operation 158 is operation 160, in which a rider or passenger is given a predefined time after notification of the driver/vehicle arrival to enter the vehicle. A predefined time, such as about 5 minutes, can be provided by the platform for both the driver/vehicle and the rider or passenger to both confirm pickup of the rider or passenger from the ride starting location. Typically, the app or application executing on the smartphone of the driver/vehicle, and on the smartphone of the rider or passenger, can provide respective options for the driver/vehicle and rider or passenger to confirm pickup from the ride starting location.

Operation 160 is followed by operation 162, in which upon pickup confirmation by both the driver/vehicle and the rider or passenger in operation 160, the ride commences and the rider or passenger's trip is in action.

Operation 162 is followed by operation 164, in which the platform can provide navigational instructions to the driver/vehicle by way of tracking the driver/vehicle via GPS coordinates and a mapping application, program, or service.

Operation 164 is followed by operation 166, in which the rider or passenger is dropped off at the ride ending location or point, and the ride or trip terminates. After the ride or trip terminates, a final price or cost can be determined by the platform, which can include the distance traveled, the time of day, the vehicle type, and the number of any additional passengers.

The embodiments described herein can provide certain technical effects including increased efficiency over conventional TNCs. Conventional TNCs can be characterized by matching a vehicle with a passenger based on the nearest passing vehicle to the passenger, regardless of how long the vehicle has been waiting empty and/or how long the vehicle traveled empty to be in the vicinity of the passenger. Further, each driver/vehicle serving a TNC is an independent contractor, i.e., an owner for his/her own business, rather than a traditional employee. This means that each driver/vehicle for the TNC does not have a set schedule. While this permits certain TNCs to minimize labor costs, it also does not permit TNCs to compel a driver/vehicle to show up at a specific place and time. This lack of control can be an inefficiency for conventional TNCs. The platform permits a driver/vehicle to have the ability to voluntarily set a plan and schedule through a selected work window as described herein. Additionally, the driver/vehicle is given a cut off time, after the initial setup, in which a work window plan and schedule change may be made to the initial work window plan and schedule if it is not yet confirmed, as indicated in a changed state from unconfirmed to confirm by the driver/vehicle to the platform. However, once the driver/vehicle work window plan and schedule is confirmed by the driver/vehicle to the platform, the driver/vehicle may no longer make changes to the confirmed work window plan and schedule, and at that point, that the platform creates a RCL specific to the driver/vehicle. Thus, this compels (though driver/vehicle volunteering actions) the designated drivers/vehicles to show up at a specific place and time, and can increase the efficiency of the platform of the TNC over conventional TNCs and platforms.

As described above, the platform can provide riders with the opportunity to book rides in advance. A master and/or initial inventory list can be generated, from which sub-lists can be created, each of which can be described as a restricted class list (RCL). Each RCL can be specific to a confirmed driver/vehicle work plan. Between the initial creation of the driver/vehicle specific RCL and the cut off time (some time before a driver/vehicle confirms and an active work window expires) for the driver/vehicle, as new rides are booked into the master inventory list, the platform can implement one or more algorithms to search the master inventory list to update each initial driver/vehicle RCL, based on better driver/vehicle utilization rates that can be obtained to achieve the objective of maximizing the driver/vehicle's revenue potential for each hour of the driver/vehicle's work window. Between the cut off time, when the driver/vehicle is no longer permitted to change a work window schedule, and the time the actual work window of the driver/vehicle will commence, a predefined time is chosen by the platform, in which the platform suspends updating the RCL. When this occurs, a final RCL list of rides is generated and the rides in the final RCL are automatically sequenced for the driver/vehicle. The driver/vehicle can then be required to follow the sequence and routing provided by the platform for picking up and dropping off the riders included in the final RCL.

In at least one embodiment, the platform can implement one or more algorithms to achieve the technical effects described above and/or one or more of the following objectives.

(1) Minimize driver/vehicle wait time between rides and letting drivers/vehicles know in advance the next ride location, pickup time and drop off/delivery points.

(2) Minimize driver/vehicle unloaded miles, which ensures that the driver/vehicle drives as few miles as possible without a paying rider onboard and gives the driver/vehicle knowledge ahead of time its work load for the confirmed work plan, while allowing the driver/vehicle to determine start and end locations for a select work plan.

(3) Maximize the driver/vehicle's revenue potential for each hour and/or active work window because of achieving the objectives in (1) and (2) above and ensuring that riders are picked up on time and as scheduled.

In the example embodiment, the following terms and calculations are used.
“Net driver/vehicle” payout is a percentage (%) of the fee charged to rider or passenger.
A fee charged to rider or passenger is based on an amount based on a rate pegged to distance per trip+estimated time travel per trip.
Estimated distance per trip is a calculation of the distance and/or time point to point route from all available routes projected by GPS coordinates between rider (Pi) pickup and drop off locations.
Estimated time travel is calculated based on the formula of distance divided by the lowest legal allowable speed limit on the route used in calculating the distance above or as estimated by a third-party GPS calculation based on the point to point route selected trip time.

In the example embodiment, an algorithmic metaheuristic search approach can be implemented using some or all of the following variables:
p₁=net driver/vehicle payout on first trip based on loaded trip distance.
p₂=net driver/vehicle payout on second trip based on loaded trip distance.
p₃=net driver/vehicle payout on third trip based on loaded trip distance.
pₙ=net driver/vehicle payout on n^{th trip} based on loaded trip distance.
pₙ₊₁=net driver/vehicle payout on n^{th+1} trip based on loaded trip distance.
P_{w}=P₁+P₂+P₃+Pₙ+Pₙ₊₁=net payout during a given work window based on sum of all loaded trip distances, where p₁, p₂, p₃, pₙ & pₙ₊₁ are calculated based on rate per mile at time of day multiplied by distance, which is derived from the difference in GPS coordinate parameters between two locations (x₁, y₁) (x₂, y₂).
t₁=net driver/vehicle payout on first trip based on actual trip minutes.
t₂=net driver/vehicle payout on second trip based on actual trip minutes.
t₃=net driver/vehicle payout on third trip based on actual trip minutes
tₙ=net driver/vehicle payout on n^{th} trip based on actual trip minutes.
tₙ₊₁=net driver/vehicle payout on n^{th+1} trip based on actual trip minutes.
T_{w}=t₁+t₂+t₃+tₙ+tₙ₊₁=net payout during a given work window based on sum of all actual trip minutes, where t₁, t₂, t₃, tₙ & tₙ₊₁ are calculated based on a rate per minute at time of day multiplied by actual trip minutes.
r₁=p₁+t₁=net driver/vehicle payout on first trip based on combined loaded trip distance and actual loaded trip minutes.
r₂=p₂+t₂=net driver/vehicle payout on second trip based on combined loaded trip distance and loaded trip minutes.
r₃=p₃+t₃=net driver/vehicle payout on third trip based on combined loaded trip distance and loaded trip minutes.
rₙ₊₁=pₙ₊₁+tₙ₊₁=net driver/vehicle payout on n^{th+1} trip based on combined loaded trip distance and loaded trip minutes.
rₙ₊₁=pₙ₊₁+tₙ₊₁=net driver/vehicle payout on n^{th+1} trip based on combined loaded trip distance and loaded trip minutes
R_{w}=P_{w}+T_{w}=net payout during a given work window based on sum of all trip loaded miles, and sum of all loaded trip minutes
Dᵤ=unloaded distance (miles).
L₁=driver/vehicle location 1 (drop off of first rider).
L₂=driver/vehicle location 2 (pickup second rider)
Dᵤ=L₂−L_{L}=unloaded miles between any two locations.
Y_{Δ}=pickup time between location 1 and location 2.
Y₁=pickup time 1 (pickup time of first rider)
Y₂=pickup time 2 (pickup time of second rider).
Y_{Δ}=Y₂−Y₁=difference in pickup times between any two riders.
Y_{w}=wait time, where Y_{w}≤Y_{Δ}.

Using some or all of the above variables, the algorithmic metaheuristic search approach can use some or all of the following optimization rules within each driver/vehicle confirmed plan or work window.

Overarching Optimization Rules:
Rule A—Maximize revenue (R_{w}) per hour>$20 per hour (for example).
Rule B—Minimize unloaded miles (Dᵤ).
Rule C—Minimize wait time between rides (Y_{w}).

Rules for pre-allocating rides to a driver/vehicle prior to a predefined platform driver/vehicle cutoff time for ride finalization, scheduling, sequencing and routing for final rides can include, for example, the following operations:

(1) As depicted in FIG. 6, for example, at the driver/vehicle start window and prior to finalization of assigned rides for a driver/vehicle, the first operation is for the platform to check the master inventory for rides within a predefined reasonable radius, such as, for example, ≤10 miles, from the driver/vehicle start location and also, for example, ≥10 miles, of the driver/vehicle desired end location. In FIG. 6, Rᵢ=initial ride in the ride inventory at start of first iteration of allocation of rides to driver/vehicle 1 (D1) and the driver/vehicle (D1)'s start location (DSL) and end location (DEL).

(2) As depicted in FIG. 7, the next operation to building the algorithmic metaheuristic search approach is to create an initial restricted candidate list (RCL) containing only two rides pickups for the driver/vehicle, where R1 equals a ride that is nearest to driver/vehicle start point, and R7 equals a ride nearest to driver/vehicle desired end point.

(3) The next operation to building the algorithmic metaheuristic search approach is to assign additional rides from the initial mastery inventory to driver/vehicle, based on (a) total estimated duration of trip rides+allowance for wait time (≤10 minutes per trip, for example); (b) ability for the ride to be completed within work window (for example, allowing approximately 10 minutes over or under of the duration time of the work window).

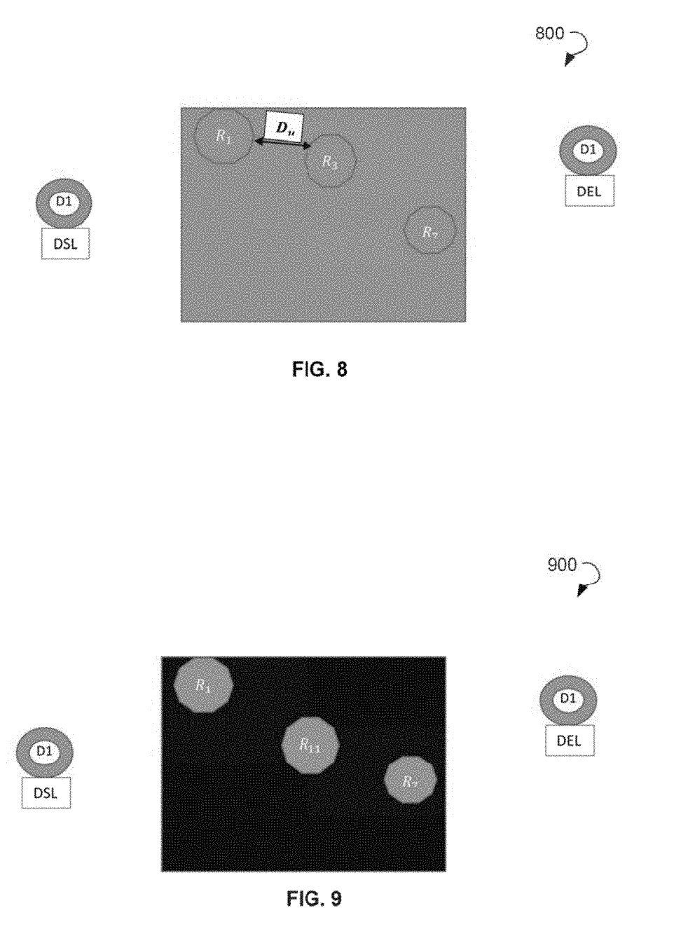

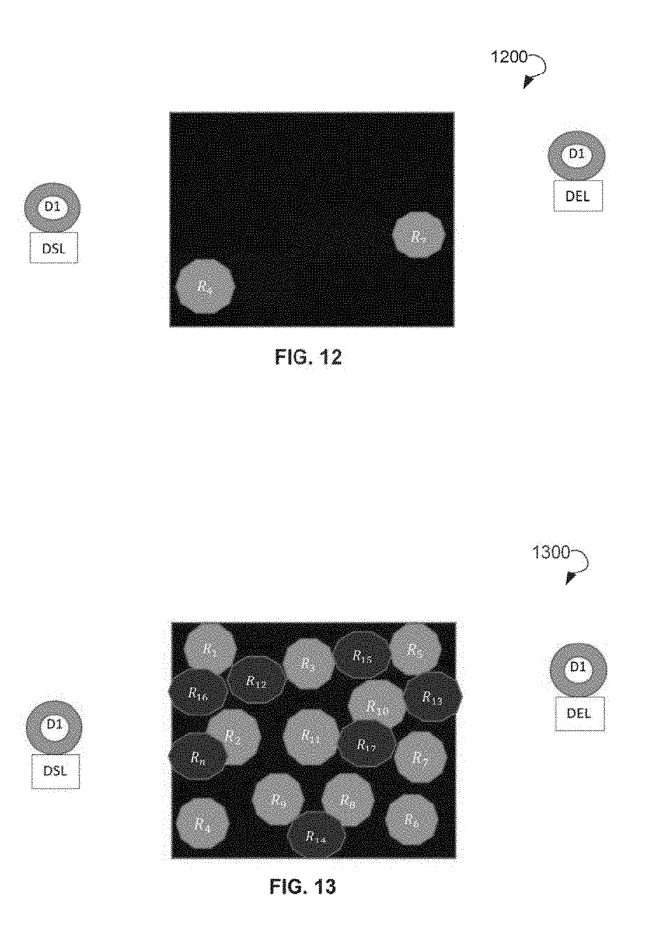

(4) As depicted in FIGS. 8-13, the next operation to building the algorithmic metaheuristic search approach is to assign rides to drivers/vehicles, taken into consideration the other optimization goals. The sub-operations for this operation can be as follows:
(a) Checking the distance between each driver/vehicle start location and first ride pickup point, applying the overarching optimization rule B, minimize unloaded miles (Dᵤ), defined above.
(b) Checking for each driver/vehicle the estimated time to complete a first assigned ride and determining if:
   (i) Time taken to complete first ride≤1 hour? If then,
      Check net payout (r₁=P₁+t₁) to driver/vehicle on first ride, by answering the question—Is net payout r₁=p₁+t₁≥$20?
         If
         Yes,
         then allocate third ride to RCL based on overarching optimization rule B and rule C (in that order).
         No
         then allocate third ride based on rule A, but checking that first ride+second ride can be completed within 1 hour.
         Check net payout (r₁+r₂) to driver/vehicle on first ride+second ride—Is net payout r₁+r₂≥$20?
         If
         Yes,
         then allocate fourth ride based on overarching optimization rule B and rule C (in that order)
         No,
         then allocate next ride based on rule A, but checking that first ride+second ride+third ride can be completed within 1 hour.
         Check net payout (r₁+r₂+r₃) to driver/vehicle on first ride+second ride+third ride—Is net payout r₁+r₂+r₃≥$20?
         Repeat this if loop until r₁+r₂+r₃+rₙ+rₙ₊₁≥$20 for the hour, then move to the next hour.
   (ii) Time taken to complete first ride>1 hour?
      Check net payout (r₁=p₁+t₁) to driver/vehicle on first ride—Is net payout r₁=p₁+t₁≥$20?
         If
         Yes,
         allocate second ride based on overarching optimization rule B and rule C (in that order)
         Continue adding additional rides from the master inventory to driver/vehicle based on (a) total estimated duration of trip rides+allowance for wait time (≤10 minutes per trip) (b) and may be completed within work window (allow for approximately 10 minutes over or under of time window).
         No,
         do not allocate first ride—go back to the ride inventory and restart RCL replacing original first ride (R1) with new first ride (R4), based on overarching optimization rule A and rule B (in that order).
         Go back to beginning of the optimization rule (4) above and go through the process again.
(5) The next operation to building the algorithmic metaheuristic search approach is that of ending ride assignments to each driver/vehicle. This can be accomplished through the following two sub-operations.
   (a) Repeating the algorithmic process above for each hour within each work window.
      (i) Repeat the processes described above, but this time around, as depicted in FIG. 12, adding the constraint of ending the loop at DEL, with last ride being the nearest rider (R7) which was added to the RCL in rule (2) described above with respect to FIG. 7.
   (b) Ending the algorithmic metaheuristic search approach for each driver/vehicle at the end of each respective driver/vehicle scheduled time window

In one embodiment, the process for the final ride allocation, scheduling, and routing of rides to be picked up by a driver/vehicle at the desired driver/vehicle cut off time when no more algorithmic planning is allowed, can include the following operations.

Between the prescheduling and final schedule cut off point, new rides can be added to the initial inventory of rides.

These new rides added can cause (a) new pickup and drop off points closer to the ones initially provisioned in the first RCL list, and (b) differently optimized paths. Therefore, during this time, the algorithmic metaheuristic search approach can continue to update and re-update the RCL, which can lead to improved optimization in the algorithmic metaheuristic search approach described above.

The optimization process described above can cease being repeated just prior to the cut off time, during which no more changes are allowed.

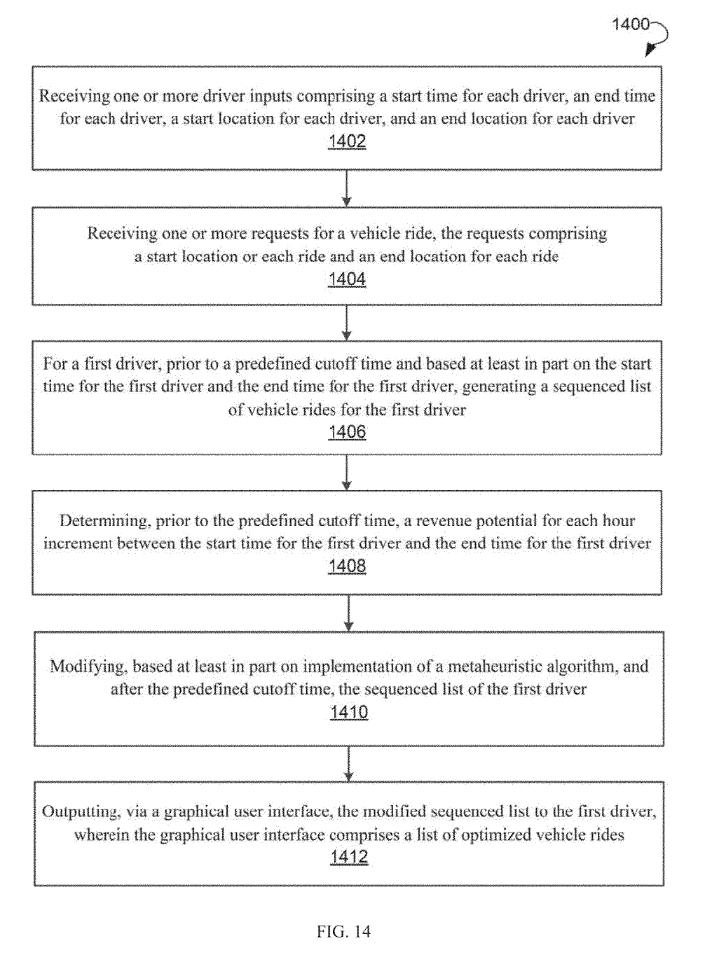

Turning to FIG. 14, an example flowchart is provided for certain systems and methods according to certain embodiments of the disclosure. In the example shown in FIG. 14, as method 1400 can begin with operation 1402, in which one or more driver inputs comprising a start time for each driver, an end time for each driver, a start location for each driver, and an end location for each driver can be received.

Operation 1402 is followed by operation 1404, in which one or more requests for a vehicle ride can be received, the requests comprising a start location for each ride and an end location for each ride.

Operation 1404 is followed by operation 1406, in which, for a first driver, prior to a predefined cutoff time and based at least in part on the start time for the first driver and the end time for the first driver, a sequenced list of vehicle rides for the first driver can be generated.

Operation 1406 is followed by operation 1408, in which, prior to the predefined cutoff time, a revenue potential for each hour increment between the start time for the first driver and the end time for the first drive can be determined.

Operation 1408 is followed by operation 1410, in which, based at least in part on implementation of a metaheuristic algorithm, and after the predefined cutoff time, the sequenced list of the first driver can be modified.

Operation 1410 is followed by operation 1412, in which the modified sequenced list can be output via a graphical user interface to the first driver, wherein the graphical user interface comprises a list of optimized vehicle rides.

In one aspect of the example method 1400 described in FIG. 14, the sequenced list can be further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver; minimizing unloaded miles, and minimizing wait time between rides.

In another aspect of the example method 1400 described in FIG. 14, the driver can be an autonomous vehicle.

In yet another aspect of the example method 1400 described in FIG. 14, the vehicle ride can be a ride for a person, package, or a pet.

In yet another aspect of the example method 1400 described in FIG. 14, the implementation of a metaheuristic algorithm can include checking an inventory of rides within a predefined distance from the start location of the first driver and the end location of the first driver; generating an initial restricted list including a ride closest to the start location of the first driver and a ride closest to the end location of the first driver; assigning rides from the inventory to the initial restricted list based at least in part on the total estimated duration of the rides, or the ability of the ride to be completed between the start time for the first driver and the end time for the first driver; minimizing unloaded miles; and minimizing wait time between rides.

In yet another aspect of the example method 1400 described in FIG. 14, the computer-implemented method can include receiving a request from a delivery recipient to modify a delivery by the first driver; further modifying, based at least in part on request from the delivery recipient, and after the predefined cutoff time, the sequenced list of the first driver; and outputting, via a graphical user interface, the further modified sequenced list to the first driver, wherein the graphical user interface comprises a list of optimized vehicle rides including a delivery to delivery recipient.

In yet another aspect of the example method 1400 described in FIG. 14, the delivery can include a package or a pet.

Other systems and methods according to embodiments of the disclosure can implement or otherwise include some or all of the above operations and aspects, while other embodiments may have fewer operations and aspects.

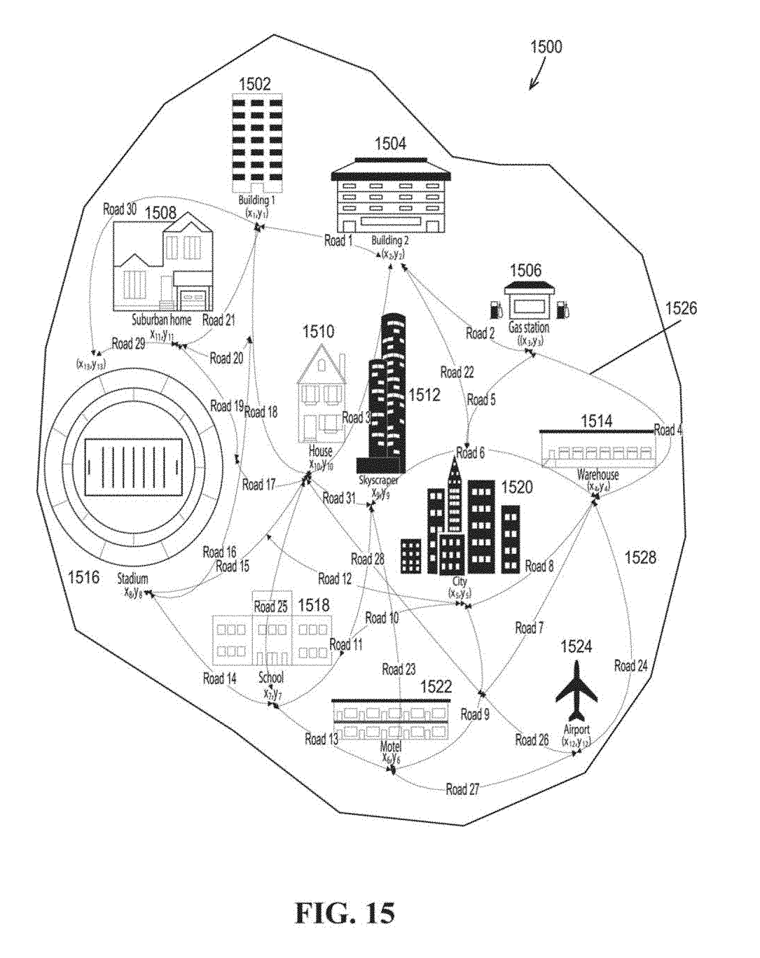

Turning to FIG. 15, in an example implementation of an embodiment of the disclosure, consider a city metropolitan area 1500 of radius about 10 miles from a city center 1502 as depicted in FIG. 15. As shown in FIG. 15, the city metropolitan area 1500 can include various different building types 1504-1524 and a road network 1526. Each building 1504-1524 can have one or more GPS longitudinal and latitudinal coordinates, shown as (xᵢ, yiᵢ). In this example depicted in FIG. 15, i=1 to 13. Each road 1528 in the road network 1526 can be numbered and, for example, can be numbered from Road 1 to Road 31.

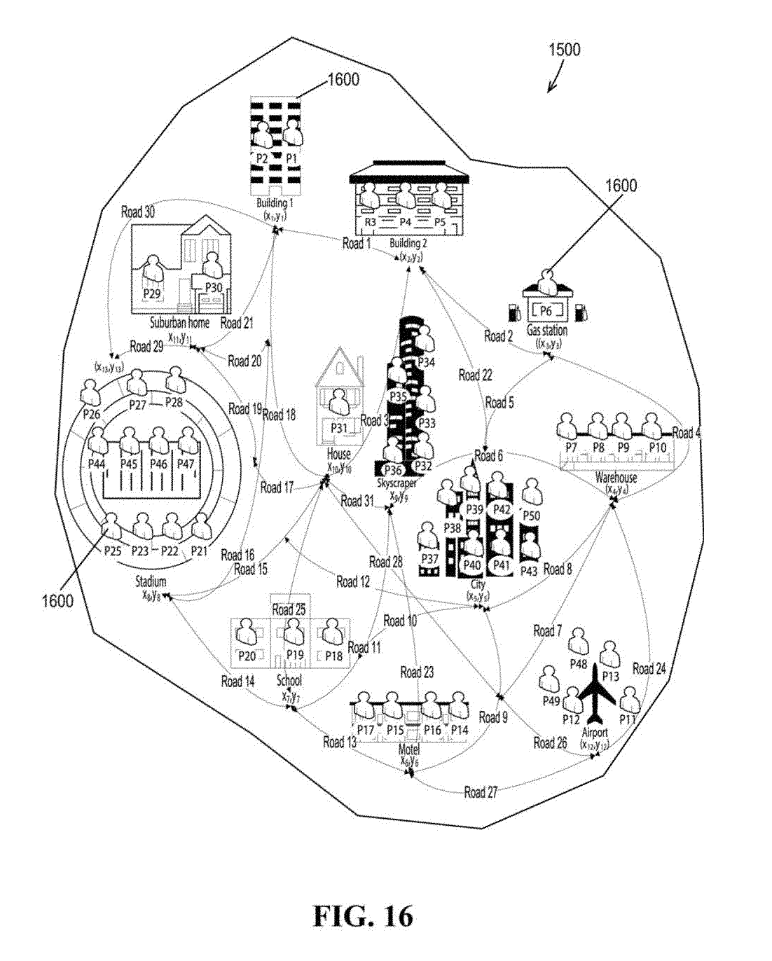

FIG. 16 shows the same city metropolitan area 1500 containing the same information as FIG. 15, but with potential passengers 1600 or riders now overladen in and around each of the buildings 1504-1524 with their respective indicating (xᵢ, yiᵢ) coordinate points.

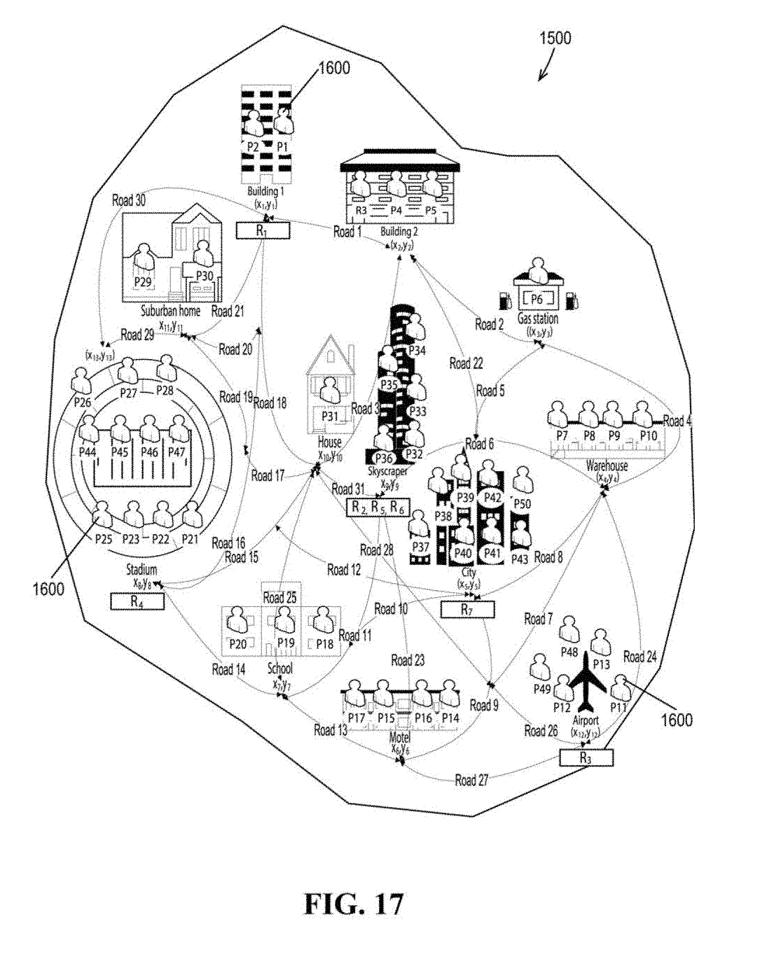

FIG. 17 shows the same city metropolitan area 1500 containing the same information as FIG. 16. However, it now shows additional information with a “snap shot” freeze into the future at 3:00 p.m. of the total ride requests from the potential passengers or riders 1600. The rides R1 to R7 are numbered and placed on the map based on the required pickup times. In this example, it may not be as relevant when the rides were booked, but of more relevance is the knowledge that the rides were booked, for example, at least about 15 minutes in advance of 3:00 p.m. Therefore, as shown in FIG. 17, at snap shot of time into the future at 3:00 p.m., there are seven rides in the master inventory list. Rides Rᵢ in the master inventory list may be of different class. For example, ride R1 may be classified as “standard” ride, corresponding to vehicle selection/request by Passenger (P1) for a standard vehicle. Ride R2 may be classified as “luxury” ride, corresponding to vehicle selection/request by Passenger (P36) for a luxury vehicle. Ride R7 may be classified as “PET” ride, corresponding to vehicle selection/request by Passenger (P50) for a Pet friendly/designated vehicle. Therefore, referencing Table 1, which shows the master inventory list at time 3:00 p.m., the total rides in the master inventory at that time (viewed at 2:00 p.m.) is 7 and these rides include different ride types. It should be noted, as shown in Table 2, that the platform may price rides using different rates (rate per mile and/or rate per minute) for each ride type and even for each ride type, depending on other factors such as time of day or promotions given, a ride type may have different rates.

As previously described with respect to the one or more algorithms implemented by the platform, a first condition to be met is pre-allocating rides to a driver/vehicle prior to a platform driver/vehicle cut off time for ride finalization, scheduling, sequencing and routing for final rides. The following 5 operations can be implemented.

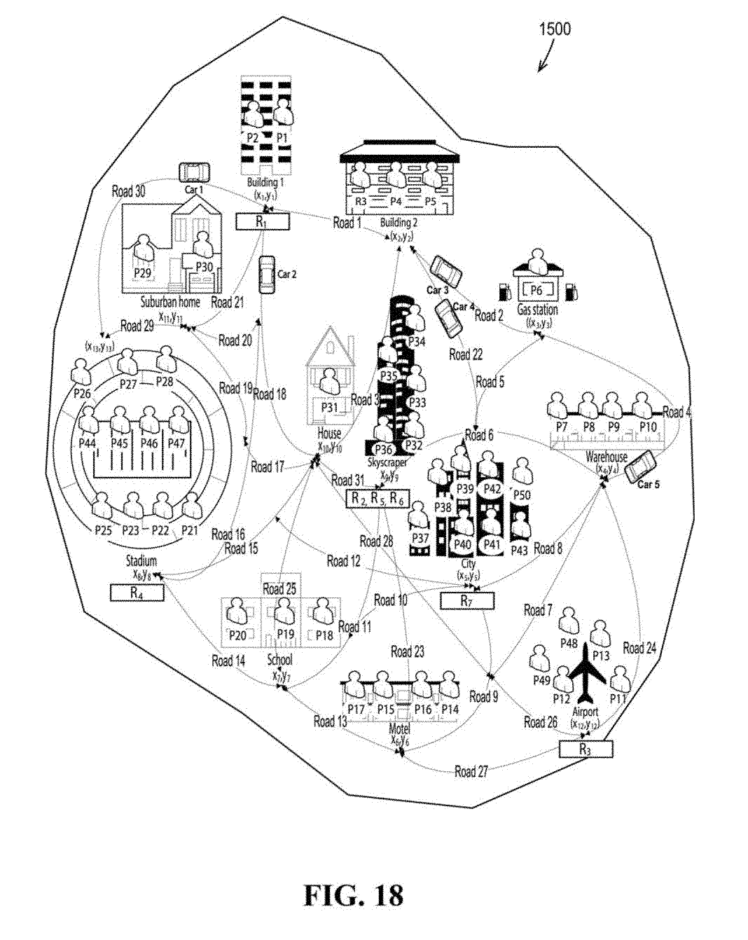

1. At the driver/vehicle start window and prior to finalization of assigned rides for a driver/vehicle, the platform checks on the master inventory (illustration shown in Table 1) for rides within a predefined radius (for example, ≤10 miles) from driver/vehicle start location and driver/vehicle desired end location is first performed. The platform can perform a search/check prior to say 2:00 p.m. for drivers/vehicles who have already setup a confirmed work window or confirmed plan. Based on this check, the platform may note that there are 5 drivers/vehicles as shown in FIG. 18. In FIG. 18, Rᵢ==7 initial rides in the ride inventory at start of first iteration of allocation of rides to the 5 driver/vehicles/(D1) to (D5) and their respective start locations (DSL) and end locations (DEL)

2. The second operation is to create an initial restricted candidate list (RCL) for each driver/vehicle containing only appropriate rides pickups for the 5 drivers/vehicles, where say R1=ride that is nearest to driver/vehicle D1 start point and R7=ride nearest to driver/vehicle D1 desired end point. This would be repeated for each of the 5 drivers/vehicles. For simplicity here, the assumption can be made that each driver/vehicle may be used for one or more types of rides. The platform can intelligently provide for allowing a driver/vehicle to be allowed to provide information if the vehicle may be used for one or more ride class or type, and create a driver/vehicle RCL based on ride class or types permissible for that specific driver/vehicle. To be able to create each driver/vehicle RCL, the platform can first look at driver/vehicle parameters as illustrated in Table 3 relative to rides in the mastery inventory as illustrated in Table 1. The platform can allocate Ride R1 to driver/vehicle D1 based on the fact that the driver/vehicle start work window is 2:50 p.m. (the ride needs to be picked up a 3:00 p.m.), the distance between designated start location of driver/vehicle work plan and the pickup point of the ride is about 3 miles (less than the maximum allowed, for example, of about 5 miles) and the time to wait and or drive to (collectively, wait time) for the ride is about 8 minutes (less than the maximum allowed, for example, of about 10 minutes). This initial assignment check/search and assignment process of the first ride is done for each driver/vehicle and as illustrated in Table 3, wherein only drivers/vehicles D1, D4 and D5 have been initially allocated a ride based on the constraints imposed. Although there are 4 other rides in the mastery inventory at this time of the platform check at 2:00 p.m., these other rides may not yet be allocated, because of certain constraints (time of pickup of rides, distance of other drivers/vehicles from rides, time to travel and or wait time for ride). However, as new rides are expected to come in before the cut of time for 3:00 p.m., the platform can continuously continue to check and the other 4 rides can eventually be allocated. In the event a ride does not get allocated before the cut off time, the platform can override the constraints to provide unallocated rides to drivers/vehicles at the very last minute or even after a driver/vehicle work plan has been made active (rides have begun to be fulfilled by a driver/vehicle within an active work plan).

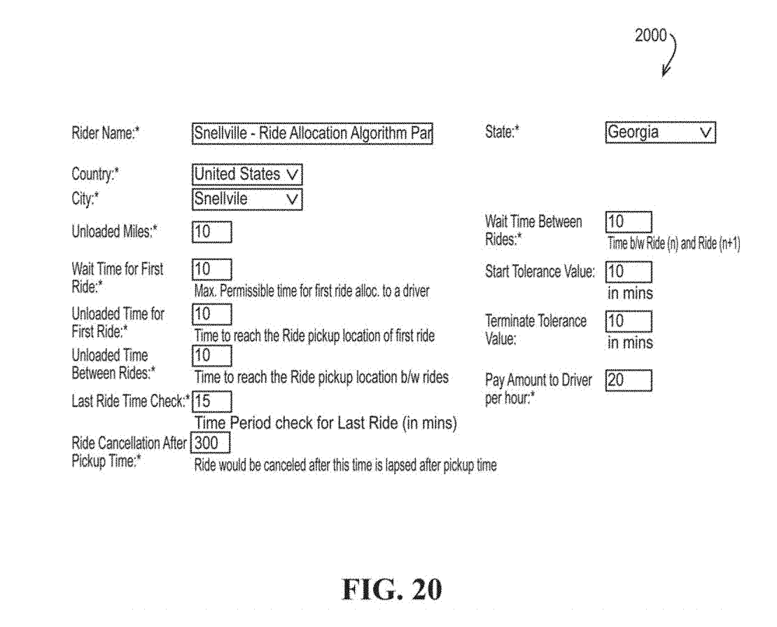

Given that the geographic area in consideration is a city metropolitan area, the platform may configure different allowable maximum unloaded (miles driven without a ride) miles for a driver/vehicle to travel for different subsections of the geographic area. For example, the geographic area may be the metropolitan area of Atlanta, Ga., United States. However, the metropolitan area of Atlanta is made up of different municipalities or cities, say Atlanta, Smyrna, Alpharetta, College Park, and Marietta. Additionally, the platform may decide to allow for maximum allowable miles, for example, about 10 miles, for the first ride allocated to a driver/vehicle for an active confirmed driver's/vehicle's work plan, but allow for different maximum allowable miles of, for example, about 5 miles, for all rides or some rides after the first ride allocated to the driver/vehicle. A similar configurable variable may also be implemented by the platform for a wait time (time waiting/traveling for/to a ride) for die first ride and rides between the first and last ride allocated to a driver/vehicle. The example user interface 2000 in FIG. 20 shows a depiction of how some or all of these features might be implemented for configuration by the platform Specific options in FIG. 20 include options to select a predefined rule name, a country, a city, a state, a number of unloaded miles, a time for a first ride, an unloaded time for a first ride, an unloaded time between rides, a last ride time check in minutes, a ride cancelation after pick up time, a wait time between rides, a start tolerance value in minutes, a terminate tolerance value in minutes, and a pay amount to driver per hour Other options and techniques for selecting or inputting data can be used for the interface according to certain embodiments of the disclosure.

3. The third operation is to assign additional rides from the initial master inventory to driver/vehicle, based on (a) total estimated duration of trip rides+allowance for wait time (≤10 minutes per trip, for example); (b) ability for the ride to be completed within work window (for example, allowing approximately 10 minutes over or under of time of the work window).

Table 4 shows an illustration of the updated RCL for each driver/vehicle based on the constraints described above and from information on rides illustrated in Table 1 showing the master inventory of rides at the time in question. Applying the constraints to each ride and driver/vehicle and executing this third step, with the baseline scenario illustrated in FIG. 17, it can now be seen from the illustration in Table 4 that driver/vehicle D1 has now been allocated, by the platform, a second Ride R2 and driver/vehicle/D4 has also been allocated a second ride R3. This can be performed for each of the other driver/vehicles from the ride master inventory list. For example, rides can be shown to be allocated to driver/vehicle D2 (R10 and R24) and D3 (R16, R21, and R37).

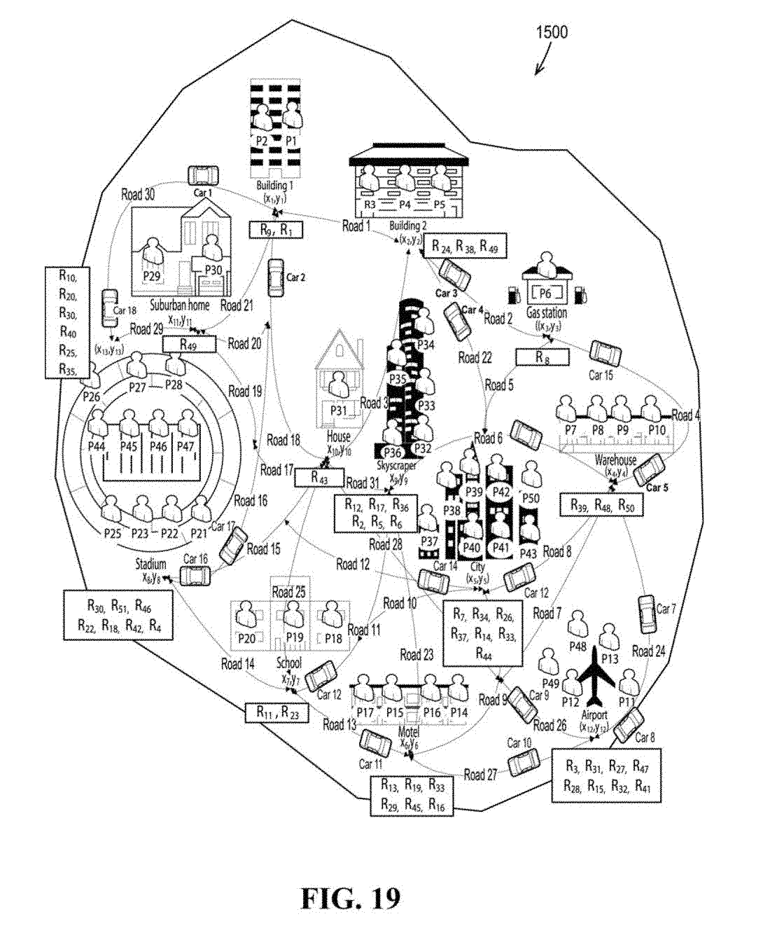

4. The fourth operation is for the platform to continue to, for example, every about 1 minute, check the master ride inventory list for new rides and driver/vehicle work windows and to assign rides to drivers/vehicles individual RCLs taking into consideration some or all of the other optimization objectives and rules. FIG. 19 can provide an illustration of a snapshot at 2:45 p.m. of the same metropolitan area 1500 depicted in FIGS. 15-18. As depicted in FIG. 19, at 2:45 p.m. there are now 50 rides and 18 drivers/vehicles with confirmed work windows or work plans. The platform can, after this point in time, suspend updates for rides to drivers/vehicles RCLs which have been allocated a first ride and where the first ride is scheduled to commence at 3:00 p.m. However, prior to this point, the platform would have implemented the following for each driver/vehicle:
a) Checking the distance between driver/vehicle start location and first ride pickup point, applying optimization rule B defined earlier.
b) Checking the estimated time to complete first ride and determining if.
   i. Time taken to complete first ride≤1 hour? If, then,
      Check net payout (r₁=p₁+t₁) to driver/vehicle on first ride, by answering the question—Is net payout r₁=p₁+t₁≥$20?
         If
         yes,
         then allocate second ride to RCL based on rule B and rule C (in that order)—Therefore, if reference is made to Table 2, in the case of driver/vehicle D1, the first ride allocated would not satisfy this condition, because the amount earned would have been $18.50 (illustrated in the last first cell of column of Table 2).
         no
         then allocate second ride based on rule A, but checking that first ride+second ride can be completed within 1 hour. Now, in the first iteration of completing the first initial RCL for driver/vehicle D1, the second ride R2 was included in the driver/vehicle forecast work plan (tentatively provisioned to driver/vehicle) illustrated in Table 4. However, from illustration data provided in Table 1, the duration of this ride R2 is estimated to be 40 minutes. Therefore R1+R2 duration is 35+40=70 minutes which is greater than 60 minutes (1 hour) [not including wait/travel time between rides]. Therefore, either ride R1 or R2 would be dropped (returned to the master inventory list) from driver/vehicle D1 initial RCL and be updated with one or more rides to satisfy this condition Referencing Table 6, in this example, ride R2 has been dropped, from driver/vehicle D1 RCL and updated with a new ride R11. Referencing FIG. 19, Ride R11, picks up at the school and drops off at the motel, which is only about 5 miles away and about an 8 minute drive. Refer to Table 5 on these illustrated data for unloaded miles and wait time. The platform has now reallocated ride R2 to driver/vehicle D14.
         Check net payout (r₁+r₂) to driver/vehicle on first ride+second ride—Is net payout r₁+r₂≥$20?—If one now assumes that Ride R11 has a (pᵢ+tᵢ) rate=$12.50, then r₁+r₂=$18.50+$12.50=$31.00≥$20. Therefore, the first 2 rides would have satisfied this condition.
         If
         yes,
         then allocate third ride based on rule B and rule C (in that order) to start second hour of driver/vehicle confirmed work plan.
         No
         then allocate next ride based on rule A, but checking that first ride+second ride+third ride can be completed within 1 hour.
         Check net payout (r₁+r₂+r₃) to driver/vehicle on first ride+second ride+third ride—Is net payout r₁+r₂+r₃≥$20?
         Repeat this if loop until r₁+r₂+r₃+rₙ+rₙ₊₁≥$20 for the hour, then move to the next hour.
   ii. Time taken to complete first ride>1 hour?
      Check net payout (r₁=p₁+t₁) to driver/vehicle on first ride—Is net payout r₁=p₁+t₂≥$20?
         If
         yes,
         allocate second ride based on rule B and rule C (in that order) to start second hour of driver/vehicle confirmed work plan.
         Continue adding additional rides from master inventory to driver/vehicle based on (a) total estimated duration of trip rides+allowance for wait time (≤10 minutes per trip) (b) and may be completed within confirmed work window (allow for approximately 10 minutes over or under of time window).
         Therefore, if reference is made to the illustrated data in Table 2, in the case of driver/vehicle D5, the first ride R7 would satisfy this condition, because the time taken (ride time) is estimated to be 70 minutes and the amount earned would have been $43.50. It should be noted here that although this ride extends the first 1 hour by 10 minutes the platform can factor in the following factors, (a) the driver/vehicle earned $43.50 for the 70 minutes ride, thus meeting and beyond optimization objective A of $20 minimum payout. (b) the ride(s) allocated to the driver/vehicle for the second one hour of the driver/vehicle confirmed work plan would allocate rides based on factor (a) here.
         No
         do not allocate first ride—go back to ride inventory and restart RCL replacing original first ride (R1) with new first ride R24, based on rule A and rule B in that order.
         Go back to beginning of section above and go through process again.

5. The fifth operation is that for ending ride assignments to drivers/vehicles. This is accomplished through the following two sub-operations.
a) Repeating the algorithm above for each hour within each work window or work plan.
   i. Repeat the processes described above, but this time around, adding the constraint of ending the loop at nearest point to the active confirmed driver/vehicle work plan.
   ii. With last ride in the driver/vehicle RCL with an end point nearest to the end point of the driver/vehicle active work plan that is being ended.

Referring to illustrated data in Table 6, it may be observed that driver/vehicle D7's last allocated ride R50, starts at the warehouse and ends at suburban home. However, the D7 work plan end point is stadium N, which is assumed to be less than about 3 miles away on route Road 29, with less than about 10 minutes of travel or wait time.
b) Ending the optimization process for driver/vehicle at the end of the driver/vehicle scheduled time window.
   a. Repeat the algorithm above with each algorithmic search.
   b. If all optimization conditions were successfully satisfied for a driver/vehicle based on previous updates, but new rides enter the master inventory that are a better match for a driver/vehicle, in terms of higher net hourly payout, lower unloaded miles or less wait/time between rides, then update driver/vehicle RCL, if by doing so another driver/vehicle optimization goal or objective is not compromised.

The process of final ride allocation, scheduling, and routing of rides to be picked up by driver/vehicle at a cut off time when no further algorithmic planning is allowed and or suspended can be implemented with the following operations.
I. Between the prescheduling and final schedule cut off point, new rides can be added to the initial master inventory of rides
II. These new rides added can cause (a) new pickup and drop off points closer to the ones initially provisioned in the first RCL list of each driver/vehicle; and (b) differently optimized paths. Therefore, during this time the platform search process can continue to update and re-update each driver/vehicle RCL, which can facilitate improved optimization in the algorithm process described above.
III. The optimization process described above can cease being repeated just prior to the cut off time, when no more updates are allowed or at the very least, updates are suspended. Suspension conditions may occur because of several reasons. Suspension here means that the software system temporarily ceases adding rides to a driver/vehicle confirmed work plan at the designated cutoff time. However, after the driver/vehicle has begun fulfilling rides in the confirmed work plan, the platform may then resume with adding or removing rides during an active work window plan. Suspension may occur for the following reasons.
   a. Drivers/vehicles may have cancelled an entire work window that had confirmed rides finalized, and these rides may then have to be redistributed to another driver/vehicle that may have already begun fulfilling rides in a confirmed work plan.
   b. Riders may also have cancelled rides at the last minute, and one or more driver/vehicle finalized RCLs may need to be updated by removing the canceled ride(s) and replacing it/them with new ride(s).
   c. In the case of long confirmed work plans (for example >4 hours) that were not fully filled with rides at cut off time and had enough rides for the duration of the confirmed work window, new rides may be added to the driver/vehicle confirmed RCL.

The detailed description outlined above provides certain examples showing each ride being routed and fulfilled sequentially one at a time by a driver/vehicle. However, the case could include “pooled” rides where more than one rides are picked up either at the same location or at separate locations, and the rides dropped off at the same location and or separate locations, while abiding by certain imposed constraints of the optimization goals or objectives.

Once the platform completes a confirmed RCL for a driver/vehicle, this optimized RCL is then presented in a format that tells the driver/vehicle the order and sequence the rides are to be fulfilled. Table 7 shows an illustration of the type of data that could be put in a graphical display to represent this information for the driver/vehicle. Note that as illustrated in Table 6, driver/vehicle D7 data shown has a confirmed work window with start time at 4:30 p.m., start location at the city coordinates, end location at the suburban home coordinates and a 4 hour work window or work plan. This information as illustrated in Table 6 and the combination from the information illustrated in FIGS. 18-19 can be used to help produce the illustrated information in Tables 7 and 8.

The information in the tables can also be used to provide GPS routing information to a driver/vehicle to allow for navigation according to a ride sequencing order as intelligently provisioned from the RCL to GPS system.

Through the algorithmic metaheuristic search approach described above, some or all of the following optimization rules for each driver/vehicle can be shown to be implemented.
Goal A—Maximize revenue (R_{w}) per hour>$20/hour (for example).
Goal B—Minimize unloaded miles (Dᵤ).
Goal C—Minimize wait time between rides (Y_{w}).

Returning to the example of driver/vehicle D7 and the finalized RCL the platform provided to the driver/vehicle and referencing illustration data provided in Table 9, the following may be observed:

For each hour in the driver/vehicle D7 confirmed work plan, which has a 4 hour duration, goal A can be achieved. For example, for the first hour P_{w}=$23.50 and T_{w}=$5.70, which gives R_{w}=P_{w}+T_{w}=$23.50+$5.70=$29.20>$20.

Referencing illustration data provided in Table 7, the total unloaded miles Dᵤ for the first hour of the driver/vehicle D7 confirmed work plan is 3 (0+3+0) miles. The objective of minimizing the unloaded mile is achieved as the ratio of loaded (travel distance) to unloaded miles for this first hour is 22:3. That is, the aim is to keep the fraction unloaded miles divided by loaded miles (in this example,

$$( \frac{3}{22} ) )$$

as small as possible.

Referencing illustration data provided in Table 7, the total wait time between rider Y_{w} for the first hour of the driver/vehicle D7 confirmed work plan is 17 (5+7+5) miles. The objective of minimizing the wait time between rider can be achieved as the ratio of travel time (travel time with a rider) to wait time between rider for this first hour is 45:17. That is, the aim is to keep the fraction wait time between rides divided by travel time with riders (in this example,

$$( \frac{17}{45} ) )$$

as small as possible.

Thus, the novel features and implementation of the platform can allow for an analysis and review of the entire driver/vehicle confirmed work plan to intelligently determine that if there are insufficient rides in a driver/vehicle RCL for the confirmed work plan, for any given hour of the duration of the work plan, for the optimization goals to be achieved, then the platform can offset the failure within one hour, by making up or otherwise compensating for in one or more hours of the same driver/vehicle work plan, such that some or all of the optimization goals can be achieved for the duration of the confirmed work plan.

Over time, if one were to express average aggregate Revenue R_{w}, average aggregate loaded miles X₁, and average aggregate travel (with passenger onboard) time X₂ of all rides in an equation, then it would be expressed as follows: R_{w}=aX₁+bX₂+Z where a, b are the rate of changes (coefficients) of the two input variables X₁ & X₂ respectively, relative to revenue R_{w}. Over time, because of the unique metaheuristic algorithmic search principles the platform would have applied, using the average aggregate X₁ and X₂ values between the sets of location coordinates [(x₁, y₁), (x₂, y₂)] and the time t of the duration for each ride Rᵢ to maximize revenue R_{w}, for any given driver/vehicle confirmed work plan.

Over time, another overarching goal of implementation by the platform would be manifested in how the platform achieved minimization of the aggregate opportunity revenue loss Y₀ of each driver/vehicle during confirmed work plans. The platform can accomplish this by minimizing the unloaded miles Dᵢ and time between ride Yᵢ for each ride during each driver/vehicle confirmed work plan. The average aggregate unloaded miles Dᵤ (D₁+D₂+Dᵢₜₕ) and average aggregate wait time Y_{w} (Y₁+Y₂+Yᵢₜₕ) expressed into a new equation as follows: Yₒ=aX₁+bX₂+cDᵤ+eY_{w}+Z, where a, b, c, and e are the rate of changes (coefficients) of the four input variables X₁, X₂, Dᵤ & Y_{w} respectively, relative to revenue Y₀. Over time, in the end what would have been observed is that the optimization techniques applied by the platform would have achieved small values for the difference between Yₒ and R_{w} (Yₒ−R_{w}) for each driver/vehicle serving the TNC network. By keeping this difference as small as possible, the platform attempts to maximize the utilization of each driver/vehicle achieved by the optimization goals of minimizing unloaded miles Dᵤ and wait time between rides Y_{w}.

In another embodiment, certain systems and methods can route vehicles and schedule vehicle rides associated with package delivery. Described earlier with respect to FIGS. 1 and 2 are capabilities and associated options to designate rides in a master inventory. For example, each ride can be defined as a respective object for moving persons, animals, and/or packages from a start location to an end location by at least one vehicle class. The rides in the master inventory can then be organized or distributed into smaller “bins” classified as RCLs, based on optimization goals and/or objectives for any number of driver/vehicle confirmed work plans. While rides are in a particular driver/vehicle RCL, there is a cutoff time in which the platform ceases or suspends updating the RCL. During the time in which the platform is generally allowed to update a RCL, if the ride or object is a package delivery request, then the platform can provide functionality to allow certain parameters (for example, name of recipient, delivery address, time of delivery) associated with the package delivery request to be updated by a recipient of the package. One aspect of this functionality is that the recipient can be provided by the platform with the ability to update shipping information prior to delivery of the package to the recipient without the involvement of the initial shipper, and wherein the initial shipper may or may not be a third party entity using the platform for package delivery services.

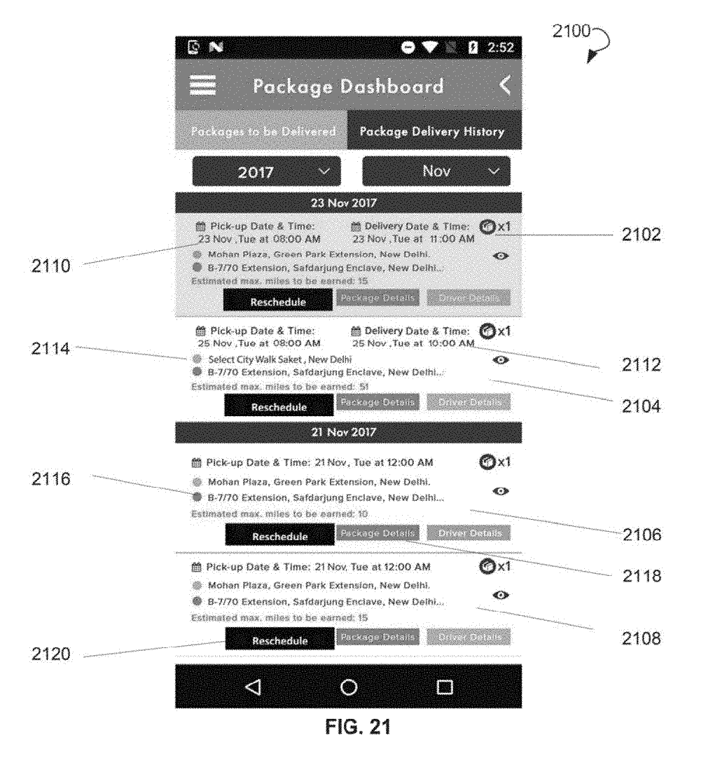

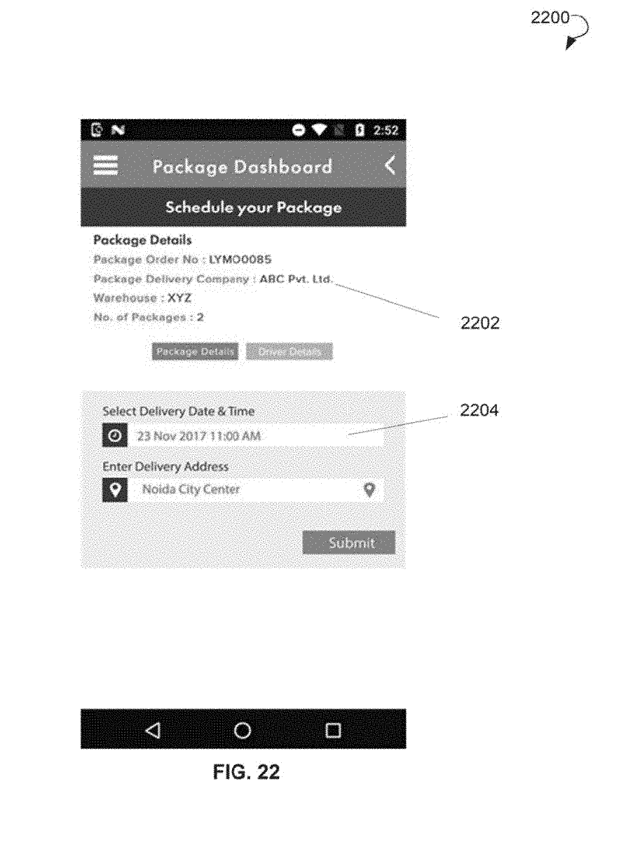

FIGS. 21 and 22 illustrate user interfaces in accordance with an embodiment of the disclosure. The respective example user interfaces 2100 shown in FIGS. 21, and 2200 in FIG. 22 can be facilitated by an app or application executing on a smartphone or other processor-based device In the example of FIG. 21, the platform can generate a user interface 2100 via an app or application executing on a smartphone or other processor-based device showing how a package recipient may be presented with information regarding one or more packages designated to be delivered to the recipient from one or more shippers. As illustrated in FIG. 21, there can be, for example, 4 rides or package deliveries 2102, 2104, 2106, 2108 earmarked by the platform for delivery to the recipient. Parameters for each package delivery such as pickup date and time 2110, pickup address delivery date and time 2112, pickup location 2114, delivery location 2116, and an option 2118 to obtain more details on a package are made available to the recipient. Further illustrated in the user interface 2100 is an example reschedule button 2120 to allow the recipient to click on to reschedule the delivery. Once the recipient has activated the “reschedule” button 2120, a separate user interface can be provided by the platform to permit recipient to update the original parameters for the selected package delivery transaction, as shown in FIG. 22.

In the example user interface 2200 of FIG. 22, the original package delivery details 2202 can be displayed. Further options and data fields can be provided, such as an option 2204 to select a new delivery date and time, and an option 2206 to designate a new delivery address can be provided on the user interface 2200. Upon entry of the new package delivery information, the information can be received by the platform, and the particular ride or package delivery can be updated with the new or received delivery information.

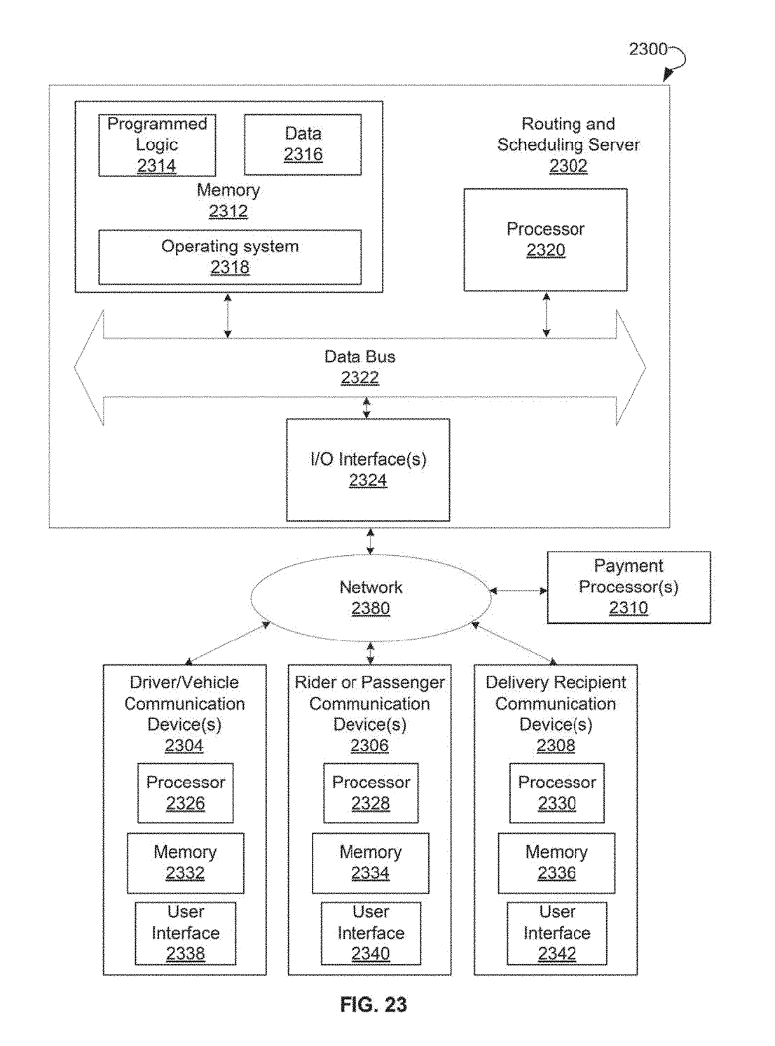

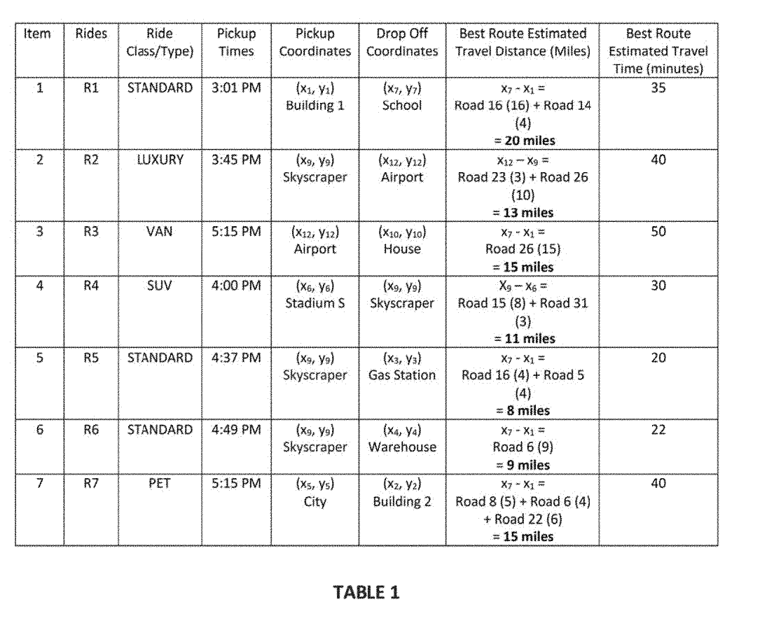

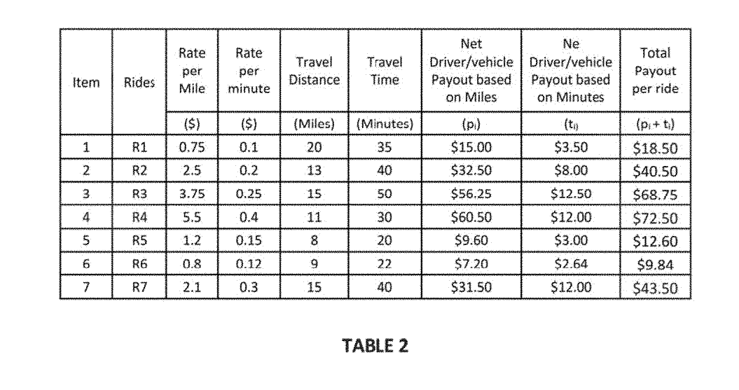

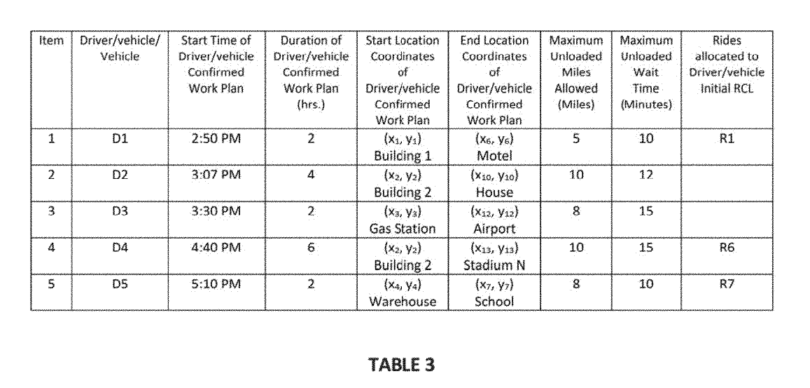

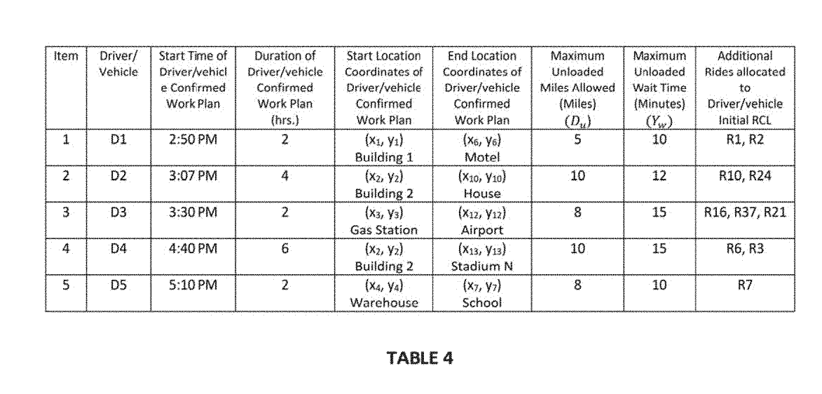

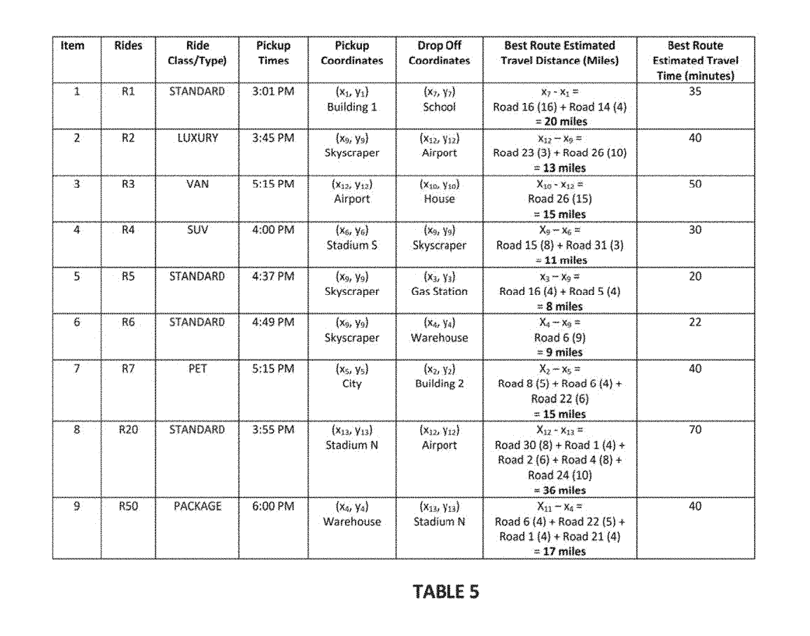

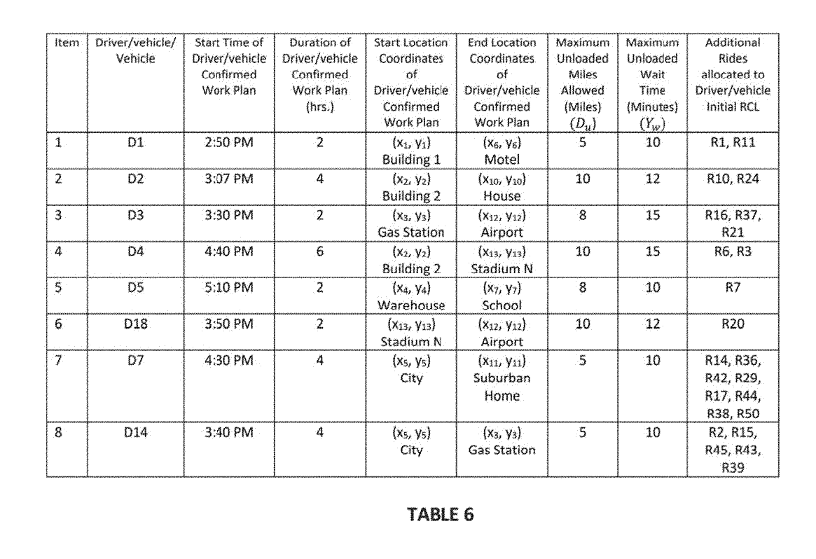

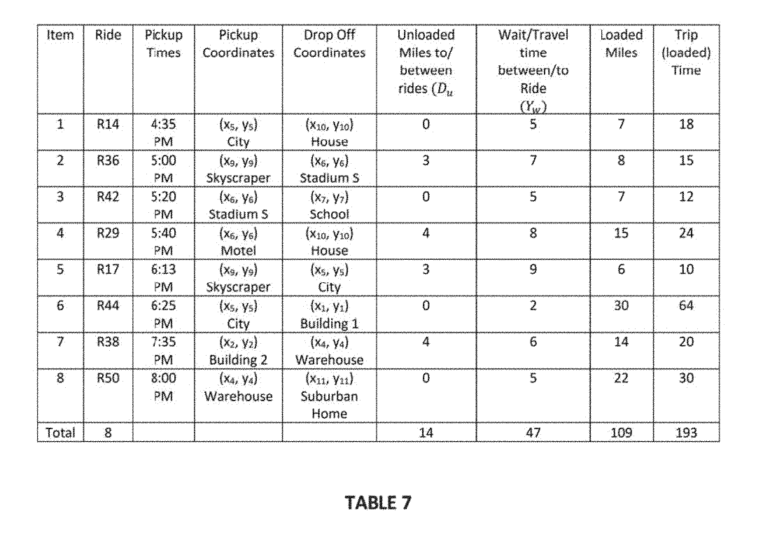

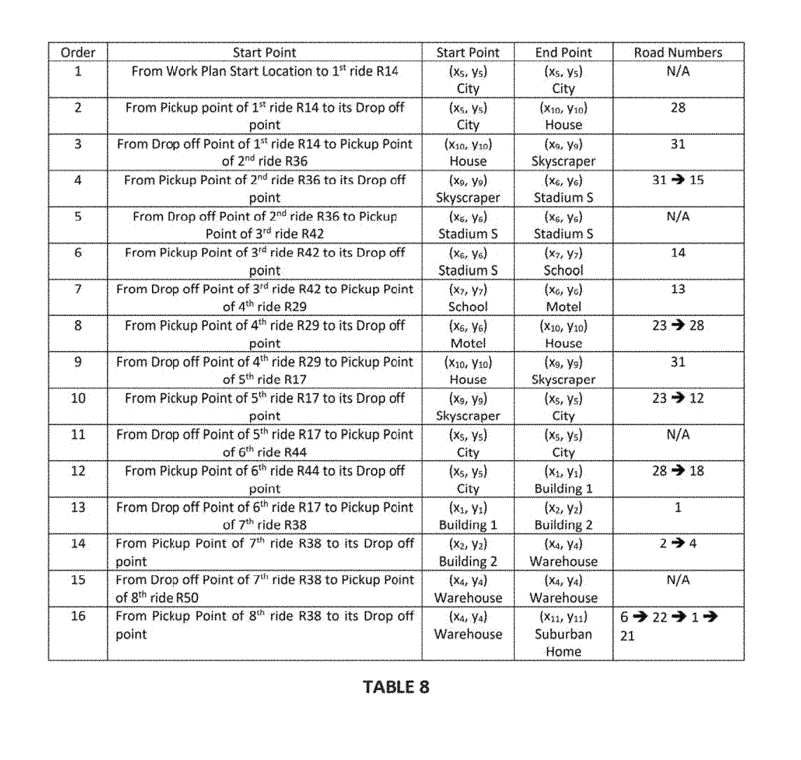

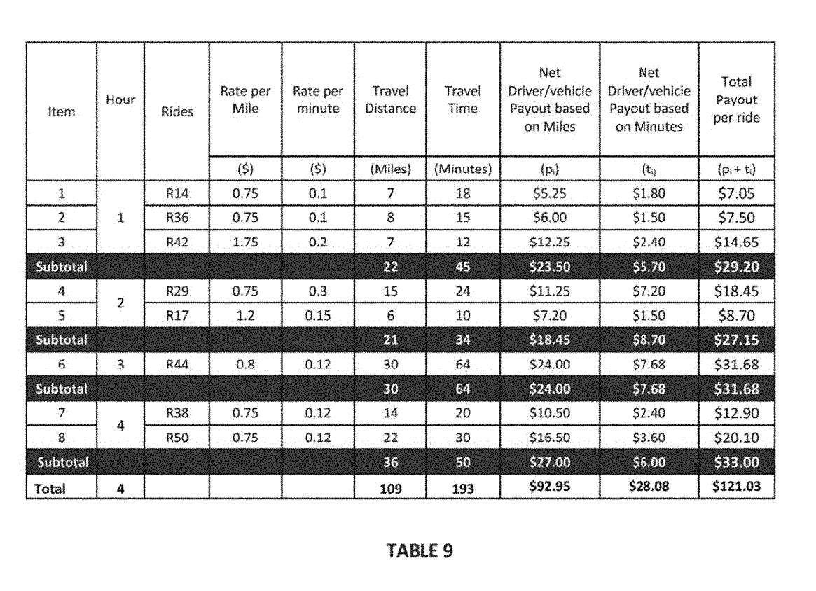

FIG. 23 illustrates an example environment and computer network architecture for communicating with driver/vehicles and passengers or riders via a network, according to certain embodiments of the disclosure. The example environment 2300 and example routing and scheduling server 2302 shown in FIG. 23 are in accordance with an embodiment of the disclosure. More specifically, the environment 2300 can be a computer-networked environment including the routing and scheduling server 2302 in communication with one or more communication devices, such as smartphones and/or processor-based devices, for example, driver/vehicle communication devices 2304, rider or passenger communication devices 2306, and delivery recipient communication devices 2308. Further, the routing and scheduling server 2302 can be in communication with one or more payment processors 2310. The communications between the routing and scheduling server 2302 and the various communication devices 2304, 2306, 2308, and payment processors 2310 can be via a network 2312, which may include wireless, wired, or both types of communications.

The routing and scheduling server 2302, also referred to as a “routing and scheduling platform” or “platform”, may be used to receive, analyze, and process driver/vehicle data, rider or passenger requests, and delivery recipient data associated with any number of rides, trips, and/or delivery requests. The routing and scheduling server 2302 may include a memory 2312 that stores programmed logic 2314 (e.g., software, non-transitory computer-readable media, computer-readable instructions, etc.) and may store data 2316, such as a master inventory, a restricted candidate list (RCL), an initial RCL, a final RCL, optimization objectives and/or goals, one or more algorithms, a set of constants, and the like. The memory 2312 also may include an operating system 2318.

A processor 2320 may utilize the operating system 2318 to execute the programmed logic 2314, and in doing so, may also utilize the data 2316. A data bus 2322 may provide communication between the memory 2312 and the processor 2320. Users may interface with the routing and scheduling server 2302 via an input/output (I/O) interface 2324, to which at least one user interface device, such as a display, keyboard, mouse, control panel, or any other device capable of communicating data to and from the routing and scheduling server 2302, may be connected or otherwise be in communication with. While operating, the routing and scheduling server 2302 may be in communication with one or more communication devices 2304, 2306, 2308 via the input/output (I/O) interface 2324. Additionally, it should be appreciated that other external devices, such as databases, cloud-based processors or storage devices, or multiple other systems and/or components may be in communication with routing and scheduling server 2302 via the I/O interface 2324. In some embodiments of the disclosure, the routing and scheduling server 2302 and the programmed logic 2314 implemented thereby may include software, hardware, firmware, or any combination thereof. It should also be appreciated that multiple routing and scheduling servers may be used, whereby different features described herein may be executed on one or more different servers.

Each of the communication devices 2304, 2306, 2308 shown in FIG. 23 can include a respective processor 2326, 2328, 2330, memory 2332, 2334, 2336, and user interface 2338, 2340, 2342. Each of the processors 2326, 2328, 2330 and memories 2332, 2334, 2336 of the communication devices 2304, 2306, 2308 can be and can have functionality similar to the processor 2320 and memory 2312 described above with respect to the routing and scheduling server 2302. Each of the processors 2326, 2328, 2330 of the communication devices 2304, 2306, 2308 can also include GPS capabilities or functionality, or can otherwise be able to utilize one or more location services to identify the location or geographic coordinates of the particular communication device on a map.

The payment processor(s) 2310 shown in FIG. 23 can be third-party payment processors operating, hosting, or otherwise facilitated by one or more payment servers operable to process a payment device, such as a credit card, debit card, charge card as well as one or more coupons or discount codes.

References are made to block diagrams of systems, methods, apparatuses, and computer program products, according to example embodiments of the disclosure. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated the disclosure may be embodied in many forms and should not be limited to the exemplary embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for routing vehicles and scheduling vehicle rides, the system comprising:
a computer processor operable to execute computer-executable instructions;
a memory comprising computer-executable instructions operable to:
receive one or more driver inputs comprising a start time for each driver, an end time for each driver, a start location for each driver, and an end location for each driver;
receive one or more requests for a vehicle ride, the requests comprising a start location or each ride and an end location for each ride;
for a first driver, prior to a predefined cutoff time and based at least in part on the start time for the first driver and the end time for the first driver, generate a sequenced list of vehicle rides for the first driver;
determine, prior to the predefined cutoff time, a revenue potential for each hour increment between the start time for the first driver and the end time for the first driver;
modify, based at least in part on implementation of a metaheuristic algorithm, and after the predefined cutoff time, the sequenced list of the first driver; and
output, via a graphical user interface, the modified sequenced list to the first driver, wherein the graphical user interface comprises a list of optimized vehicle rides.

2. The system of claim 1, wherein the sequenced list is further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver, minimizing unloaded miles, and minimizing wait time between rides.

3. The system of claim 1, wherein the driver is an autonomous vehicle.

4. The system of claim 1, wherein the vehicle ride is a ride for a person, package, or a pet.

5. The system of claim 1, wherein the implementation of a metaheuristic algorithm comprises computer-executable instructions operable to:
check an inventory of rides within a predefined distance from the start location of the first driver and the end location of the first driver;
generate an initial restricted list including a ride closest to the start location of the first driver and a ride closest to the end location of the first driver;
assign rides from the inventory to the initial restricted list based at least in part, on the total estimated duration of the rides, or the ability of the ride to be completed between the start time for the first driver and the end time for the first driver,
minimize unloaded miles; and
minimize wait time between rides.

6. The system of claim 1, wherein the computer-executable instructions further comprise instructions operable to:
receive a. request from a delivery recipient to modify a delivery by the first driver; and
further modify, based at least in part on request from the delivery recipient, and after the predefined cutoff time, the sequenced list of the first driver; and
output, via a graphical user interface, the further modified sequenced list to the first driver, wherein the graphical user interface comprises a list of optimized vehicle rides including a delivery to delivery recipient.

7. The system, of claim 6, wherein the delivery comprises a package or a pet.

8. A computer-implemented method for routing vehicles and scheduling vehicle rides, the method comprising:
receiving one or more driver inputs comprising a. start, time for each driver, an end time for each driver, a start location for each driver, and an end location for each driver;
receiving one or more requests for a vehicle ride, the requests comprising a start location or each ride and an end location for each ride;
for a first driver, prior’ to a predefined cutoff time and based at least in part on the start time for the first driver and the end time for the first driver, generating a sequenced list of vehicle rides for the first, driver;
determining, prior to the predefined cutoff time, a revenue potential for each hour increment between the start time for the first driver and the end time for the first driver;
modifying, based at least, in part on implementation of a metaheuristic algorithm, and after the predefined cutoff time, the sequenced list of the first driver; and
outputting, via a graphical user interface, the modified sequenced list to the first driver, wherein the graphical user interface comprises a list of optimized vehicle rides.

9. The method of claim 7, wherein the sequenced list is further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start, time for the first driver and the end time for the first driver, minimizing unloaded miles, and minimizing wait time between rides.

10. The method of claim 7, wherein the driver is an autonomous vehicle.

11. The method of claim 7, wherein the vehicle ride is a ride for a person, package, or a pet.

12. The method of claim 7, wherein the implementation of a metaheuristic algorithm comprises:
checking an inventory of rides within a predefined distance from the start location of the first driver and the end location of the first driver;
generating an initial restricted list, including a ride closest to the start location of the first driver and a ride closest to the end location of the first driver;
assigning rides from the inventory to the initial restricted list based at least in part on the total estimated duration of the rides, or the ability of the ride to be completed between the start time for the first driver and the end time for the first driver;
minimizing unloaded miles; and
minimizing wait time between rides.

13. The method of claim 7, further comprising:
receiving a request from a delivery recipient to modify a delivery by the first driver; and
further modifying, based at least in part on request, from the delivery recipient, and after the predefined cutoff time, the sequenced list of the first driver; and
outputting, via a graphical user interface, the further modified sequenced list to the first driver, wherein the graphical user interface comprises a list of optimized vehicle rides including a delivery to delivery recipient.

14. The method of claim 13, wherein the delivery comprises a package or a pet.

15. One or more computer-readable media comprising computer-executable instructions operable to:
receive one or more driver inputs comprising a start time for each driver, an end time for each driver, a. start location for each driver, and an end location for each driver;
receive one or more requests for a vehicle ride, the requests comprising a start location or each ride and an end location for each ride;
for a first driver, prior to a predefined cutoff time and based at least in part on the start time for the first driver and the end time for the first driver, generate a sequenced list of vehicle rides for the first driver;
determine, prior to the predefined cutoff time, a revenue potential for each hour increment between the start time for the first driver and the end time for the first driver;
modify, based at least in part on implementation of a metaheuristic algorithm, and after the predefined cutoff time, the sequenced fist of the first driver; and
output, via a graphical user interface, the modified sequenced list to the first driver, wherein the graphical user interface comprises a list of optimized vehicle rides.

16. The one or more computer-readable media of claim 15, wherein the sequenced list is further based at least in part on: a predefined radius from the start location for the first driver, a predefined radius from the end location for the first driver, a ride nearest the start location for the first driver, a ride nearest the end location for the first driver, a total estimated duration of all rides, ability for a ride to be completed between the start time for the first driver and the end time for the first driver; minimizing unloaded miles, and minimizing wait time between rides.

17. The one or more computer-readable media of claim 15, wherein the driver is an autonomous vehicle.

18. The one or more computer-readable media of claim 15, wherein the vehicle ride is a ride for a person, package, or a pet,

19. The one or more computer-readable media of claim 15, wherein the implementation of a metaheuristic algorithm comprises computer-executable instructions operable to:
check an inventory of rides within a predefined distance from the start location of the first driver and the end location of the first driver;
generate an initial restricted list including a ride closest to the start location of the first driver and a ride closest to the end location of the first driver;
assign rides from the inventory to the initial restricted list based at least in part on the total estimated duration of the rides, or the ability of the ride to be completed between the start time for the first driver and the end time for the first driver;
minimize unloaded miles; and
minimize wait time between rides.

20. The one or more computer-readable media of claim 15, wherein the computer-executable instructions further comprise instructions operable to:
receive a request from a delivery recipient to modify a delivery by the first driver; and
further modify, based at least in part on request from the delivery recipient, and after the predefined cutoff time, the sequenced list of the first driver; and
output, via a graphical user interface, the further modified sequenced list to the first driver, wherein the graphical user interface comprises a list of optimized vehicle rides including a delivery to delivery recipient.
